(19) United States
(12) Patent Application Publication
(10) Pub. No.: US 2026/0019959 A1
(43) Pub. Date: Jan. 15, 2026

(54) SYSTEMS, APPARATUSES, METHODS, AND NON-TRANSITORY COMPUTER-READABLE STORAGE DEVICES FOR MULTI-LINK OPERATIONS IN WIRELESS LOCAL-AREA NETWORK

(71) Applicant: HUAWEI TECHNOLOGIES CO., LTD., Shenzhen (CN)

(72) Inventors: Mahmoud Hasabelnaby, Kelowna (CA); Osama Aboul-Magd, Kanata (CA); Jung Hoon Suh, Kanata (CA); Yan Xin, Kanata (CA); Sara Norouzi, Vancouver (CA)

(21) Appl. No.: 18/816,157

(22) Filed: Aug. 27, 2024

Related U.S. Application Data
(60) Provisional application No. 63/669,475, filed on Jul. 10, 2024.

(51) Int. Cl. H04W 52/36; H04W 24/02; H04W 52/24; H04W 76/15; H04W 84/12

(52) U.S. Cl. CPC H04W 52/367; H04W 24/02; H04W 52/243; H04W 76/15; H04W 84/12

(57) ABSTRACT

A communication method comprises sending, from a multi-link device, a minimum transmit power and a maximum transmit power for each of at least a first and a second communication links; and before a start of a scheduled service period, receiving a local transmit power constraint for the scheduled service period (SP) for a corresponding communication link. If a frequency gap between the first and the second communication links is equal to or smaller than a threshold and if the scheduled service period overlaps with another scheduled service period for the other one of the first and second communication links, the local transmit power constraints for the first and second communication links are set to correspond to the respective minimum transmit powers. The method enables simultaneous uplink and downlink transmissions over in-device coexistence (IDC)-impacted links by adjusting the transmission power values for the scheduled SPs over the affected links.

### CROSS-REFERENCE TO RELATED APPLICATIONS

This application claims the benefit of U.S. Provisional Patent Application Ser. No. 63/669,475, filed Jul. 10, 2024, the content of which is incorporated herein by reference in its entirety.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for power-controlled multi-link operations in wireless local-area network (WLAN) with in-device coexistence (IDC) (e.g., cross-link interference) awareness.

### BACKGROUND

In wireless local-area network (WLAN) systems, the multi-link simultaneous transmit and receive (STR) transmission mode, as outlined in IEEE P802.11be/D5.0-35.3.16.3, permits access point (AP) and/or non-AP multi-link devices (MLDs) to asynchronously transmit frames on multiple different links. Each affiliated AP or non-AP station (STA) maintains its own channel access parameters, behaving independently of the others. STR facilitates concurrent uplink (UL) and downlink (DL) communications. However, such system can have high power consumption and can be affected by in-device coexistence (IDC) interference.

Therefore, there is a desire for power control while addressing the IDC issues.

### SUMMARY

According to one aspect of this disclosure, there is provided a first communication method comprising: sending, from a multi-link device (MLD), a minimum transmit power and a maximum transmit power for each of at least a first communication link and a second communication link for use by at least a first communication component and a second communication component of the MLD, respectively; and before a start of a scheduled service period, receiving a local transmit power constraint for the scheduled service period for a corresponding one of the first and second communication links; wherein if a frequency gap between the first communication link and the second communication link is equal to or smaller than a threshold and if the scheduled service period overlaps with another scheduled service period for the other one of the first and second communication links, the local transmit power constraints for the first and second communication links correspond to the respective minimum transmit powers.

In some embodiments, if the frequency gap between the first communication link and the second communication link is larger than the threshold, the local transmit power constraints for the first and second communication links correspond to values smaller than or equal to the respective maximum transmit powers and greater than the respective minimum transmit powers.

In some embodiments, if the frequency gap between the first communication link and the second communication link is equal to or smaller than the threshold and the scheduled service period does not overlap with another scheduled service period for the other one of the first and second communication links, the local transmit power constraints for the first and second communication links correspond to values smaller than or equal to the respective maximum transmit powers and greater than the respective minimum transmit powers.

In some embodiments, said sending the minimum transmit power and the maximum transmit power for each of the first communication link and the second communication link comprises sending, via an association request frame, the minimum and maximum transmit powers for each of the first and second communication links; wherein the association request frame comprises a multi-link power capability element, the multi-link power capability element comprising a control field and a transmit power capabilities field specifying the minimum and maximum transmit powers for each of the first and second communication links; and wherein the control field comprising a number of links subfield for indicating a number of a plurality of communication links specified in the transmit power capabilities field, the plurality of communication links comprising the first and second communication links In some embodiments, said receiving the local transmit power constraint for the scheduled service period for the corresponding one of the first and second communication links comprises receiving a power-controlled Target Wake Time (TWT) information frame specifying the local transmit power constraint for the scheduled service period for the corresponding one of the first and second communication links.

In some embodiments, the first communication method further comprises receiving, by the MLD, an association response frame containing a TWT element, wherein a TWT information frame disabled subfield of the TWT element is set to a predetermined value to indicate that reception of the power-controlled TWT information frame is enabled by at least one of a plurality of communication components of the MLD, the plurality of communication components comprising the first and second communication components.

In some embodiments, the power-controlled TWT information frame comprises an action field containing an unprotected sub-1-GHz (S1G) action subfield, and a predetermined value of the unprotected S1G action field represents a power-controlled TWT information frame.

In some embodiments, said sending the minimum transmit power and the maximum transmit power for each of the first communication link and the second communication link comprises: sending, via an association request frame, the minimum and maximum transmit powers for each of the first and second communication links; wherein the association request frame comprises a first power-controlled TWT element, the first power-controlled TWT element comprising a power-controlled TWT parameter information field specifying the minimum and maximum transmit powers for each of one or more of a plurality of communication components of the MLD, the plurality of communication components comprising the first and second communication components.

In some embodiments, the first power-controlled TWT element further comprises a control field containing a power-controlled TWT information frame disabled subfield, wherein a value of the power-controlled TWT information frame disabled subfield indicates both a capability of receiving power-controlled TWT information frames and a presence of the minimum and maximum transmit powers for each of the one or more of the plurality of communication components in the power-controlled TWT parameter information field.

In some embodiments, the first communication method further comprises receiving, by the MLD, an association response frame containing a second power-controlled TWT element, wherein a value of a power-controlled TWT information frame disabled subfield of the second power-controlled TWT element indicates that reception of power-controlled TWT information frames is enabled by at least one of a plurality of communication components of the MLD, the plurality of communication components comprising the first and second communication components.

According to one aspect of this disclosure, there is provided a second communication method comprising: receiving, from a multi-link device (MLD), a minimum transmit power and a maximum transmit power for each of at least a first communication link and a second communication link for use by at least a first communication component and a second communication component of the MLD, respectively; and before a start of a scheduled service period, notifying a local transmit power constraint for the scheduled service period for a corresponding one of the first communication link and second communication link; wherein if a frequency gap between the first communication link and the second communication link is equal or smaller than a threshold and if the scheduled service period overlaps with another scheduled service period for the other one of the first communication link and second communication link, the local transmit power constraints for the first and second communication links correspond to the respective minimum transmit powers.

In some embodiments, if the frequency gap between the first communication link and the second communication link is larger than the threshold, the local transmit power constraints for the first and second communication links correspond to values smaller than or equal to the respective maximum transmit powers and greater than the respective minimum transmit powers.

In some embodiments, if the frequency gap between the first communication link and the second communication link is equal to or smaller than the threshold and the scheduled service period does not overlap with another scheduled service period for the other one of the first and second communication links, the local transmit power constraints for the first and second communication links correspond to values smaller than or equal to the respective maximum transmit powers and greater than the respective minimum transmit powers.

In some embodiments, said receiving the minimum transmit power and the maximum transmit power for each of the first communication link and the second communication link comprises receiving, via an association request frame, the minimum and maximum transmit powers for each of the first and second communication links; wherein the association request frame comprises a multi-link power capability element, the multi-link power capability element comprising a control field and a transmit power capabilities field specifying the minimum and maximum transmit powers for each of the first and second communication links; and wherein the control field comprising a number of links subfield for indicating a number of a plurality of communication links specified in the transmit power capabilities field, the plurality of communication links comprising the first and second communication links.

In some embodiments, said notifying the local transmit power constraint for the scheduled service period for the corresponding one of the first communication link and second communication link comprises transmitting a power-controlled TWT information frame specifying the local transmit power constraint for the scheduled service period for the corresponding one of the first communication link and second communication link.

In some embodiments, the second communication method further comprises sending, by the MLD, an association response frame containing a TWT element, wherein a TWT information frame disabled subfield of the TWT element is set to a predetermined value to indicate that reception of the TWT information frame is enabled by at least one of a plurality of communication components of the MLD, the plurality of communication components comprising the first and second communication components.

In some embodiments, the power-controlled TWT information frame comprises an action field containing an unprotected sub-1-GHz (S1G) action subfield, and a predetermined value of the unprotected S1G action field represents a power-controlled TWT information frame.

In some embodiments, said receiving the minimum transmit power and the maximum transmit power for each of the first communication link and the second communication link comprises: receiving, via an association request frame, the minimum and maximum transmit powers for each of the first and second communication links; wherein the association request frame comprises a first powered-controlled TWT element, the first powered-controlled TWT element comprising a power-controlled TWT parameter information field specifying the minimum and maximum transmit powers for each of one or more of a plurality of communication components of the MLD, the plurality of communication components comprising the first and second communication components.

In some embodiments, the power-controlled TWT element further comprises a control field containing a power-controlled TWT information frame disabled subfield, wherein a value of the power-controlled TWT information frame disabled subfield indicates both a capability of receiving power-controlled TWT information frames and a presence of the minimum and maximum transmit powers for each of the one or more of the plurality of communication components in the power-controlled TWT parameter information field.

In some embodiments, the second communication method further comprises sending, by the MLD, an association response frame containing a second power-controlled TWT element, wherein a value of a power-controlled TWT information frame disabled subfield of the second power-controlled TWT element indicates that reception of power-controlled TWT information frames is enabled by at least one of a plurality of communication components of the MLD, the plurality of communication components comprising the first and second communication components.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus comprising: one or more processors functionally connected to one or more memories for performing the above-described methods.

According to one aspect of this disclosure, there is provided one or more non-transitory computer-readable storage devices comprising computer-executable instructions, wherein the instructions, when executed, cause one or more circuits to perform the above-described methods.

According to one aspect of this disclosure, there is provided an apparatus, and configured to perform the any one of above-mentioned methods and their embodiments. Specifically, the apparatus includes one or more units configured to perform the any one of above-mentioned methods and their embodiments.

According to one aspect of this disclosure, there is provided a computer-readable storage medium. The computer-readable storage medium stores a computer program, and when the computer program is executed by an apparatus, the apparatus is enabled to implement the any one of above-mentioned methods and their embodiments.

According to one aspect of this disclosure, there is provided a computer program product including one or more instructions. When the instructions are executed by an apparatus such as a computer, the apparatus is enabled to implement the any one of above-mentioned methods and their embodiments.

According to one aspect of this disclosure, there is provided a computer program. When the computer program is executed by a computer, an apparatus is enabled to implement the any one of above-mentioned methods and their embodiments.

According to one aspect of this disclosure, there is provided a communication system. The communication system includes a first communication node and/or a second communication node, the first communication node is configured to perform the first communication methods as stated above, and the second communication node is configured to perform the second communication methods as stated above.

According to one aspect of this disclosure, there is provided an apparatus for implementing the methods in any possible implementation of the foregoing aspects.

According to one aspect of this disclosure, there is provided a first communication apparatus for use as a first communication node in a MLD, the first communication apparatus comprising at least one processing unit and at least one transceiver, wherein: the at least one transceiver is configured to send a minimum transmit power and a maximum transmit power for each of at least a first communication link and a second communication link for use by at least a first communication component and a second communication component of the MLD, respectively; and before a start of a scheduled service period, receive a local transmit power constraint for the scheduled service period for a corresponding one of the first and second communication links; and wherein if a frequency gap between the first communication link and the second communication link is equal to or smaller than a threshold and if the scheduled service period overlaps with another scheduled service period for the other one of the first and second communication links, the local transmit power constraints for the first and second communication links correspond to the respective minimum transmit powers.

In some embodiments, said at least one transceiver being configured to send the minimum transmit power and the maximum transmit power for each of the at least the first and second communication links comprises: said at least one transceiver being configured to send, via an association request frame, the minimum and maximum transmit powers for each of the first and second communication links; wherein the association request frame comprises a multi-link power capability element, the multi-link power capability element comprising a control field and a transmit power capabilities field specifying the minimum and maximum transmit powers for each of the first and second communication links; and wherein the control field comprising a number of links subfield for indicating a number of a plurality of communication links specified in the transmit power capabilities field, the plurality of communication links comprising the first and second communication links.

In some embodiments, said at least one transceiver being configured to receive the local transmit power constraint for the scheduled service period for the corresponding one of the first and second communication links comprises said at least one transceiver being configured to receive a power-controlled TWT information frame specifying the local transmit power constraint for the scheduled service period for the corresponding one of the first and second communication links.

In some embodiments, said at least one transceiver is further configured to: receive an association response frame containing a TWT element, wherein a TWT information frame disabled subfield of the TWT element is set to a predetermined value to indicate that reception of the power-controlled TWT information frame is enabled by at least one of a plurality of communication components of the MLD, the plurality of communication components comprising the first and second communication components.

In some embodiments, wherein said at least one transceiver being configured to send the minimum transmit power and the maximum transmit power for each of at least the first communication link and the second communication link comprises: said at least one transceiver being configured to send, via an association request frame, the minimum and maximum transmit powers for each of the first and second communication links; wherein the association request frame comprises a first power-controlled TWT element, the first power-controlled TWT element comprising a power-controlled TWT parameter information field specifying the minimum and maximum transmit powers for each of one or more of a plurality of communication components of the MLD, the plurality of communication components comprising the first and second communication components.

In some embodiments, said at least one transceiver is further configured to: receive an association response frame containing a second power-controlled TWT element, wherein a value of a power-controlled TWT information frame disabled subfield of the second power-controlled TWT element indicates that reception of power-controlled TWT information frames is enabled by at least one of a plurality of communication components of the MLD, the plurality of communication components comprising the first and second communication components.

According to one aspect of this disclosure, there is provided a second communication apparatus for use as a second communication node in a MLD, the second communication apparatus comprising at least one processing unit and at least one transceiver, wherein: the at least one transceiver is configured to receive a minimum transmit power and a maximum transmit power for each of at least a first communication link and a second communication link for use by at least a first communication component and a second communication component of the MLD, respectively; and before a start of a scheduled service period, notify a local transmit power constraint for the scheduled service period for a corresponding one of the first and second communication links; and wherein if a frequency gap between the first communication link and the second communication link is equal to or smaller than a threshold and if the scheduled service period overlaps with another scheduled service period for the other one of the first and second communication links, the local transmit power constraints for the first and second communication links correspond to the respective minimum transmit powers.

In some embodiments, said at least one transceiver being configured to receive the minimum transmit power and the maximum transmit power for each of the at least the first and second communication links comprises: said at least one transceiver being configured to receive, via an association request frame, the minimum and maximum transmit powers for each of the first and second communication links; wherein the association request frame comprises a multi-link power capability element, the multi-link power capability element comprising a control field and a transmit power capabilities field specifying the minimum and maximum transmit powers for each of the first and second communication links; and wherein the control field comprising a number of links subfield for indicating a number of a plurality of communication links specified in the transmit power capabilities field, the plurality of communication links comprising the first and second communication links.

In some embodiments, said at least one transceiver being configured to notify the local transmit power constraint for the scheduled service period for the corresponding one of the first and second communication links comprises said at least one transceiver being configured to transmit a power-controlled TWT information frame specifying the local transmit power constraint for the scheduled service period for the corresponding one of the first and second communication links.

In some embodiments, said at least one transceiver is further configured to: send an association response frame containing a TWT element, wherein a TWT information frame disabled subfield of the TWT element is set to a predetermined value to indicate that reception of the power-controlled TWT information frame is enabled by at least one of a plurality of communication components of the MLD, the plurality of communication components comprising the first and second communication components.

In some embodiments, wherein said at least one transceiver being configured to receive the minimum transmit power and the maximum transmit power for each of at least the first communication link and the second communication link comprises: said at least one transceiver being configured to receive, via an association request frame, the minimum and maximum transmit powers for each of the first and second communication links; wherein the association request frame comprises a first power-controlled TWT element, the first power-controlled TWT element comprising a power-controlled TWT parameter information field specifying the minimum and maximum transmit powers for each of one or more of a plurality of communication components of the MLD, the plurality of communication components comprising the first and second communication components.

In some embodiments, said at least one transceiver is further configured to: send an association response frame containing a second power-controlled TWT element, wherein a value of a power-controlled TWT information frame disabled subfield of the second power-controlled TWT element indicates that reception of power-controlled TWT information frames is enabled by at least one of a plurality of communication components of the MLD, the plurality of communication components comprising the first and second communication components.

The systems, apparatuses, methods, and non-transitory computer-readable storage devices disclosed herein provide various advantageous effects.

For example, unlike previous works that reschedule overlapped SPs over interfering links at different times at different times, the systems, apparatuses, methods, and non-transitory computer-readable storage devices disclosed herein adjust the transmission power values on the in-device coexistence (IDC) impacted links, thereby enabling simultaneous uplink and downlink transmissions over IDC-impacted links and mitigating or even eliminating the otherwise significant issue of IDC interference in simultaneous transmit and receive (STR) multi-link operations; Accordingly, the systems, apparatuses, methods, and non-transitory computer-readable storage devices disclosed herein enable multi-link STR operations with maximized throughput and minimized latency, thereby exhibiting a significant improvement over previous methods that often require rescheduling overlapped SPs over interfering links at different times at different times which compromises the throughput and latency.

In some embodiments, the systems, apparatuses, methods, and non-transitory computer-readable storage devices disclosed herein are particularly beneficial for delay-sensitive applications such as Internet-of-things (IoT) devices operations and online gaming, wherein the delay requirements are stringent, and applying restricted channel access or rescheduling overlapped SPs over interfering links at different times may not be feasible in these scenarios.

In some embodiments, the systems, apparatuses, methods, and non-transitory computer-readable storage devices disclosed herein use various signaling approaches for the TWT scheduling parameters and power capabilities information exchange/update between access point (AP) MLDs and non-AP MLDs (such as station (STA) MLDs), such as extending a power capability element to multi-link operations, and/or introducing a power-controlled TWT element for specifying power capability information. A power-controlled TWT information frame (including a power-controlled TWT information field) is also introduced for informing an affiliated STA the local transmit power constraint for each schedule SP. These extended elements and information frames represent significant enhancements in the management of multi-link operations.

In some embodiments, the method disclosed herein provides a clear and measurable criterion for managing transmission power in a network to handle IDC interference during STR multi-link operations, which reduces the complexity involved in network management, and is a significant improvement over prior-art methods (which often involved complex end-time alignment, or transmission/transmission (TX/TX) and/or receiving/receiving (RX/RX) operations synchronization).

In some embodiments, the method disclosed herein provides flexible power control based on the frequency gap between affiliated STAs, the presence of IDC interference, and the dynamic changes of the network. Such a flexibility allows the system to maintain good performance and minimize interference in various scenarios, making it a more robust and adaptable solution.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing multi-link simultaneous transmit and receive (STR) operations between a STA multi-link device (MLD) and an AP MLD;

FIG. 5 is a schematic diagram showing target wake time (TWT) scheduling of service and doze periods between the STA MLD and the AP MLD as shown in FIG. 4;

FIG. 6 is a schematic diagram showing in-device coexistence (IDC) interference in multi-link STR operations;

FIG. 7 is a schematic diagram showing a power-controlled TWT method for managing the IDC interference in multi-link STR operations, according to some embodiments of this disclosure;

FIG. 8 is a schematic diagram showing the detail of a power-controlled TWT algorithm, according to some embodiments of this disclosure;

FIG. 9 is a schematic diagram showing the structure of a multi-link power capability element of a (re)association request frame, according to some embodiments of this disclosure;

FIG. 10 is a schematic diagram showing the structure of a control field of the multi-link power capability element shown in FIG. 9;

FIG. 11 is a schematic diagram showing the structure of a transmit power capabilities field of the multi-link power capability element shown in FIG. 9;

FIG. 12 is a schematic diagram showing the structure of a control field in a TWT element of a (re)association request frame, according to some embodiments of this disclosure;

FIG. 13 is a schematic diagram showing the structure of a power-controlled TWT information field in a power-controlled TWT information frame, according to some embodiments of this disclosure;

FIG. 14 is a schematic diagram showing the structure of a power-controlled TWT element of a (re)association request frame, according to some embodiments of this disclosure;

FIG. 15 is a schematic diagram showing the structure of a control field of the power-controlled TWT element shown in FIG. 14;

FIG. 16 is a schematic diagram showing the structure of a power-controlled TWT parameter information field of the power-controlled TWT element shown in FIG. 14;

FIG. 17 is a schematic diagram showing a first example of the control field of the power-controlled TWT element, when the power-controlled TWT information frame disabled subfield is set to zero (0);

FIG. 18 is a schematic diagram showing the first example of the power-controlled TWT parameter information field of the power-controlled TWT element, when the power-controlled TWT information frame disabled subfield is set to zero (0) as shown in FIG. 17 and the request type subfield is set to one (1);

FIG. 19 is a schematic diagram showing a second example of the control field of the power-controlled TWT element, when the power-controlled TWT information frame disabled subfield is set to one (1);

FIG. 20 is a schematic diagram showing the second example of the power-controlled TWT parameter information field of the power-controlled TWT element, when the power-controlled TWT information frame disabled subfield is set to one (1) as shown in FIG. 19 and the request type subfield is set to one (1);

FIG. 21 is a schematic diagram showing a third example of the control field of the power-controlled TWT element, when the power-controlled TWT information frame disabled subfield is set to zero (0) or one (1);

FIG. 22 is a schematic diagram showing the third example of the power-controlled TWT parameter information field of the power-controlled TWT element, when the request type subfield is set to zero (0);

FIG. 23 is a schematic diagram of a power-controlled multi-link operation method, according to some embodiments of this disclosure;

FIG. 24 is a flow chart of a first communication method, according to some embodiments of this disclosure;

FIG. 25 is a flow chart of a second communication method, according to some embodiments of the disclosure.

### DETAILED DESCRIPTION

Embodiments disclosed herein relate to wireless communication systems, apparatuses, methods, and non-transitory computer-readable storage devices for power-controlled multi-link operations in wireless local-area network (WLAN). The wireless communication systems, apparatuses, methods and non-transitory computer-readable storage devices disclosed herein are suitable for multi-link simultaneous transmit and receive (STR) operations with in-device coexistence (IDC) awareness. The wireless communication systems, apparatuses, and methods disclosed herein may be any suitable systems, apparatuses, and methods for transmitting wireless signals. Examples of such systems may be wireless local-area network (WLAN) ultra-high reliability (UHR) systems (for example, IEEE 802.11bn or WI-FI® 8 systems), 5G or 6G wireless mobile communication systems, and the like.

### A. System Structure

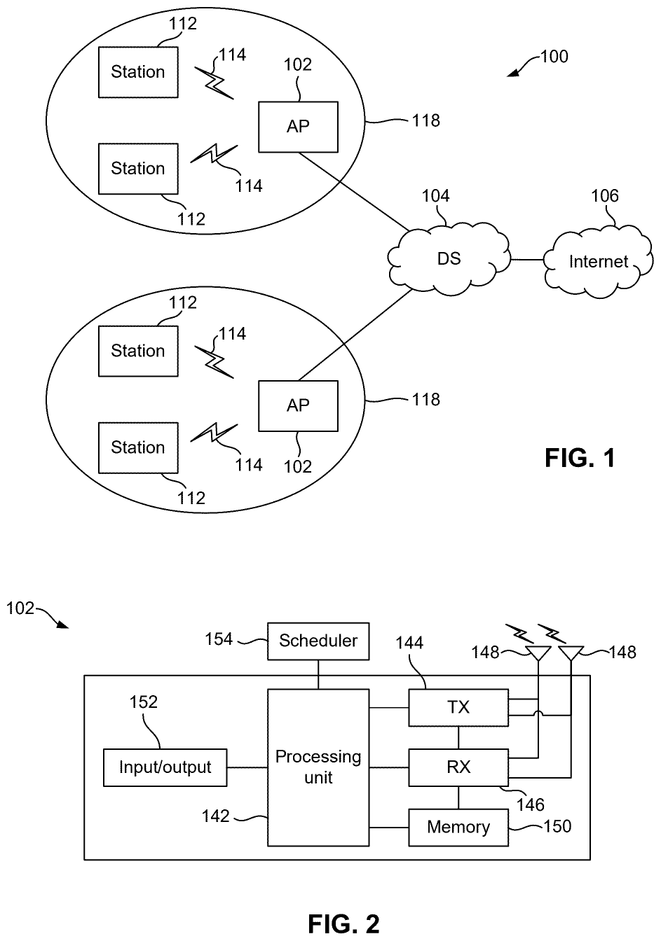

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX; also used as the abbreviation of “transmission”) 144, at least one receiver (RX; also used as the abbreviation of “receiving”) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

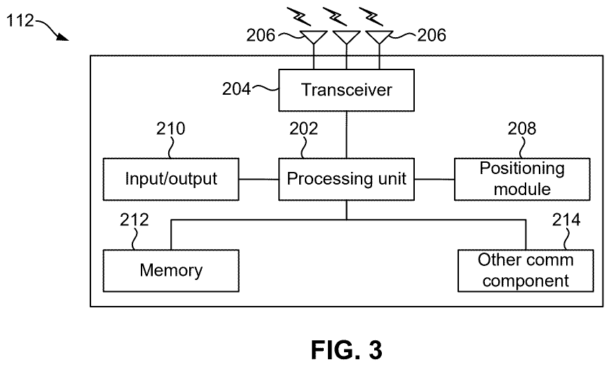

FIG. 3 is a simplified schematic diagram of a STA 112. As shown, the STA 112 comprises at least one processing unit 202, at least one transceiver 204, at least one antenna or network interface controller (NIC) 206, at least one positioning module 208, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the STA 112. The navigation satellites may be satellites of a global navigation satellite system (GNSS) such as the Global Positioning System (GPS) of USA, Globa″naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the STA 112.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is partitioned into a plurality orthogonal subchannels for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. IDC-Aware Power-Controlled Multi-Link Simultaneous Transmit and Receive Operations in WLAN

The communication system 100 may operate in the multi-link STR transmission mode, which permits AP/non-AP multi-link devices (MLDs) to asynchronously transmit frames on multiple different links.

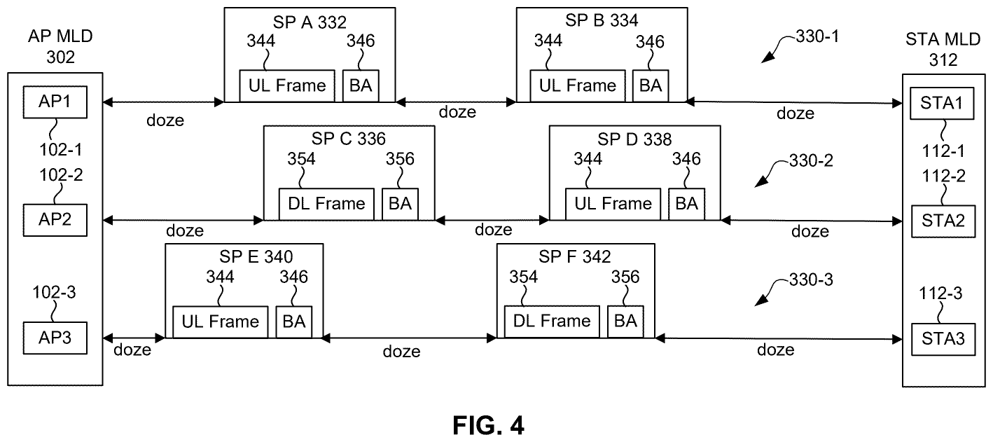

FIG. 4 is a schematic diagram showing multi-link STR operations. As shown, an AP MLD 302 may establish a plurality of links with a plurality of devices (such as one or more STA MLDs 312). For simplicity of notation, the component of the AP MLD 302 responsible for establishing a link is denoted as an affiliated AP 102. Similarly, a non-AP MLD 312 such as a STA MLD may establish a plurality of links with a plurality of devices (such as one or more AP MLDs 302). For simplicity of notation, the component of the non-AP MLD 312 (such as a STA MLD) responsible for establishing a link is denoted as an affiliated device (such as an affiliated STA 112). In the example shown in FIG. 4, there are three operation links 330-1, 330-2, 330-3, established between component 112-1 and component 102-1, between component 112-2 and component 102-2, and between component 112-3 and component 102-3, respectively.

The communication system 100 may implement a Target Wake Time (TWT) mechanism according to IEEE P802.11be (IEEE P802.11be/D5.0-35.3.24 & 35.8). The TWT mechanism is a power-saving technique, allowing the AP MLD 302 and the non-AP MLD (such as a STA MLD) 312 to negotiate specific times when they will wake up from a low-power doze mode to exchange data. The periods during which the components of the AP MLD 302 and the STA MLD 312 have negotiated to be awake are referred to as service periods (SPs). Outside of the SPs, the components of the STA MLD 312 can go into the low-power doze periods to save power.

Referring to FIG. 4, on link 1 330-1 established between STA1 112-1 and AP1 102-1, STA1 112-1 may transmit, in a scheduled service period A 332, one or more UL frames 344 to AP1 102-1, and AP1 102-1 may send one or more block acknowledgements (BAs) 346 to STA1 112-1 for acknowledging successful reception of the UL frames 344. STA1 112-1 may schedule one or more SPs with the AP MLD 302 including a service period A 332 and a service period B 334. Outside of the SPs 332, 334, STA1 112-1 and AP1 102-1 can go into doze mode to save power.

On link 2 330-2 established between STA2 112-2 and AP2 102-2, AP2 102-2 may transmit, in a service period C 336, one or more DL frames 354 to STA2 112-2; and STA2 112-2 may send one or more BAs 356 to AP2 102-2 for acknowledging successful reception of the DL frames 354. During another scheduled service period 338 on this link, STA2 112-2 may transmit one or more UL frames 344 to AP2 102-2. AP2 102-2 may in turn send one or more BAs 346 to acknowledge successful reception of frames 344. Similarly, outside of the SPs 336, 338, STA2 112-2 and AP2 102-2 can go into doze mode to save power.

On link 3 330-3 established between STA3 112-3 and AP3 102-3, STA3 112-3 may transmit, in a service period E 340, one or more UL frames 344 to AP3 102-3; and AP3 102-3 may also transmit, in a service period F 342, one or more DL frames 354 to STA3 112-3. AP3 102-3 and STA3 112-3 may send one or more BAs 346 and 356 to acknowledge successful reception of frames 344 and 354, respectively. Outside of the SPs 340, 342, STA3 112-3 and AP3 102-3 can go into doze mode to save power.

Several types of TWT agreements can be implemented according to the IEEE 802.11be standard. Individual TWT agreements between the AP MLD 302 and non-AP MLD 312 can define the wake-up schedule for each link individually, optimizing power efficiency for traffic on the corresponding link. If the quality of service (QoS) traffic needs and power-saving requirements are significantly different on each link, individual TWT agreements allow for tailored optimization on a per-link basis. In contrast, broadcast TWT is an agreement sent by the AP MLD 302 to the non-AP MLD 312, applicable to some or all links between the pair. The broadcast TWT sets a schedule for the affiliated STAs included in the broadcast group to wake up. If some or all links between the non-AP MLD 312 and AP MLD 302 have similar traffic patterns and power requirements, a single broadcast TWT agreement can simplify management and reduce overhead. As an extension of the broadcast TWT, restricted TWT (r-TWT) according to the IEEE 802.11be standard may be used, particularly in real-time applications which are characterized by strict guaranteed delay requirements. r-TWT provides affiliated STAs exclusive channel access within negotiated SPs. In other words, only the members of the r-TWT agreement can transmit data within an r-TWT SP, while all other STAs must finish their transmissions prior to the start of this SP.

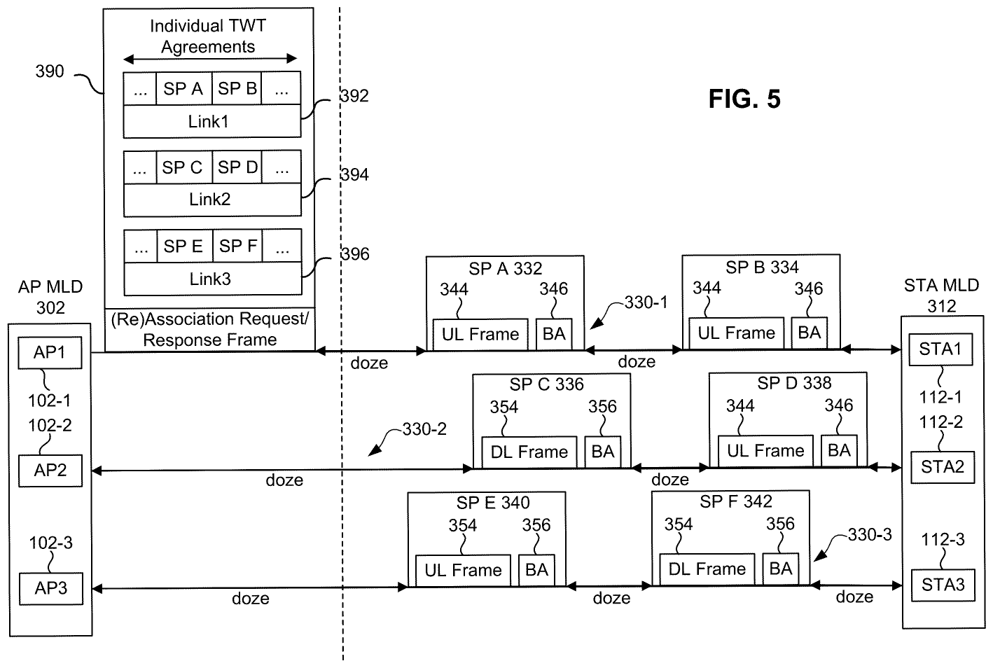

To efficiently schedule a TWT operation under the multi-link operation (MLO) framework, TWT agreements (i.e., negotiation phase) can be performed for the different enabled links through a single link, as shown in FIG. 5.

Referring to FIG. 5, the TWT agreements 390 can be performed through a single link, e.g., through link 1 330-1 established between AP1 102-1 and STA1 112-1. The TWT agreements 390 can be included in management frames exchanged between the AP MLD 302 and non-AP MLD 312. For example, the STA1 112-1 can send to the AP1 102-1 an association or reassociation request frame (also denoted as “(re)association request frame”) and the AP1 102-1 in turn can respond to the STA1 112-1 with an association or reassociation response frame (also denoted as “(re)association response frame”). Each of the (re)association request frame and the (re)association response frame can contain individual TWT agreements 392, 394, 396 for the corresponding affiliated STA 112-1, 112-2, 112-3 specifying the scheduling parameters for their SPs. The (re)association request frames can be transmitted when for example, a non-AP STA 112 is joining and leaving wireless networks and moving associations from one AP to another AP.

In the multi-link STR transmission mode, each affiliated AP or STA can maintain its own channel access parameters, behaving independently of the others. STR facilitates concurrent UL and DL communications. There are several advantages to this approach. It allows for independent channel contention on all links and enables independent transmission and reception on all links. This offers a high potential for increased throughput. However, there are also some drawbacks. The AP MLD 302 and/or non-AP MLD 312 can experience high power consumption and can be affected by IDC interference.

More specifically, the STR transmission mode can lead to a cross-link interference over overlapped scheduled SPs between the AP MLD 302 and the STA MLD 312 due to IDC emission unless their channels are sufficiently distant from each other. This interference primarily occurs between insufficiently separated channels in a band, for instance, two channels in the 5 GHz band with a very small channel gap. When IDC interference occurs, it inevitably impacts ongoing transmissions and receptions over the affected links. If IDC occurs during reception, it reduces the signal-to-interference-plus-noise ratio (SINR), which often leads to packet losses.

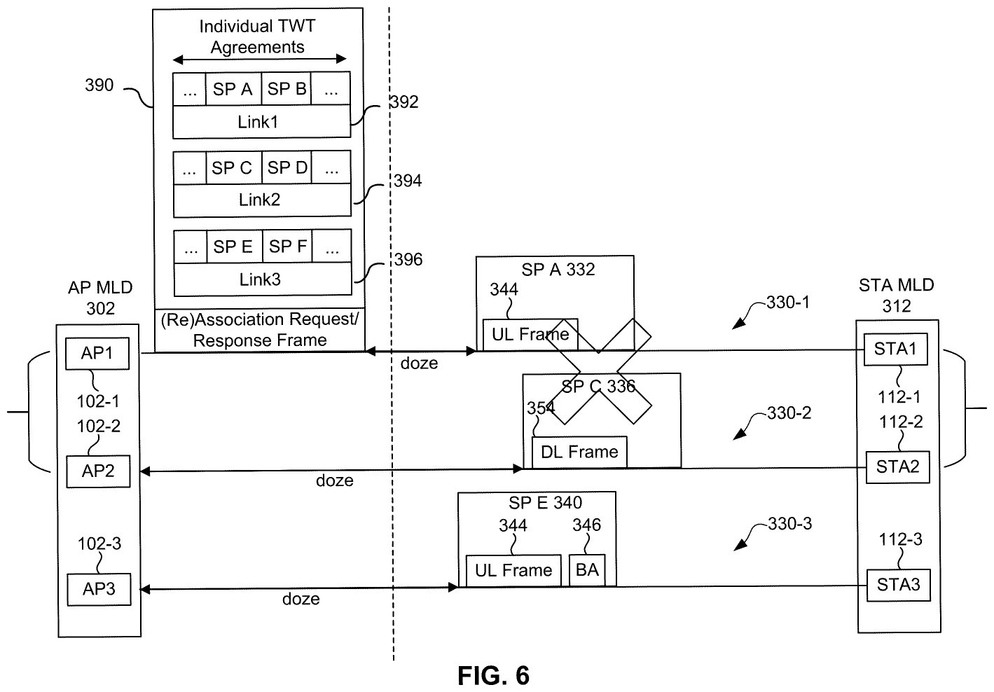

For example, as illustrated in FIG. 6, if a channel separation (i.e. frequency gap) between link 1 330-1 and link 2 330-2 is not sufficiently large, transmissions on these two links 330-1 and 330-2, such as the UL frame 344 on link 1 330-1 and the DL frame 354 on link 2 330-2, may interfere with each other (which is called “IDC interference”; may also be referred to as cross-link interference). In other words, IDC would occur between overlapped UL/DL transmissions on link 1 330-1 and link 2 330-2, if such overlapped transmissions exist. Usually, the severity of this IDC interference directly depends on how far apart the channels are on which these links operate. The closer the channels, the stronger the IDC interference. When the IDC interference is strong, no UL transmission is possible on link 1 330-1 if link 2 330-2 is busy with DL transmission, and no DL transmission is possible on link 2 330-2 if link 1 330-1 is busy with UL transmission. Because of an insufficient channel separation between link 1 330-1 and link 2 330-2, potential IDC may exist. On the other hand, if a channel separation between link 3 330-3 and link 1 330-1 is sufficiently large, there will not be any IDC issue between link 3 330-3 and link 1 330-1. Similarly, if a channel separation between link 3 330-3 and link 2 330-2 is sufficient, there will not be any IDC issue between this link pair either. Even if overlapped SPs may exist between these link pairs (e.g., SP E 340 being overlapped with SP A 332, and SP E 340 being overlapped with SP C 336), no IDC would occur because of sufficient channel separations.

Addressing the IDC issues for the STR mode in multi-link operation is one of the important goals for the TGbn group and is crucial for improving the performance and reliability of the entire network. During an IDC event, an AP MLD 302 or a non-AP MLD 312 might be unable to communicate with the intended non-AP MLD 312 or AP MLD 302 using the previously agreed-upon parameters, and sometimes it may not be feasible to avoid IDC interference by selecting sufficiently distant operating channels across the multi-links. As a result, the STR operation mode requires methods for mitigating or reducing the IDC interference to ensure efficient operation with ultra-high reliability (UHR).

IDC interference mitigation methods have been proposed in MLO. However, existing solutions often require aligning transmissions between interfering links, scheduling overlapped SPs for interfering links at different times, or limiting activities on one of the interfering links. Sometimes these approaches support a non-simultaneous transmit and receive (NSTR) operation to mitigate the IDC interference.

While the issue of IDC is addressed with the previous approaches, it comes at the expense of reduced achievable throughput at the AP/non-AP MLDs with transmit/receive constraints. AP/non-AP MLDs are unable to transmit on one link and receive on another adjacent interfering link simultaneously due to potential IDC power leakage. Under certain conditions, multi-link operation may converge to a single link operation, which is not ideal.

There is also an increase in complexity, particularly in end-time alignment methods, due to the required synchronization of transmit and receive operations.

Furthermore, for time-sensitive applications, such as IoT communications and online gaming applications, the delay requirements are stringent. In such cases, it may not be feasible to schedule overlapped SPs for interfering links at different times. This presents a significant disadvantage of the previous methods. In these scenarios, the AP MLD must accept the SP scheduling as requested by affiliated STAs associated with the STA MLD without any changes even if it might lead to IDC interference.

In the following, various embodiments of a power-controlled multi-link operation method that supports STR within overlapped SPs over interfering links are disclosed. The power-controlled multi-link operation method manages the IDC interference for STR MLO. The power-controlled multi-link operation method also embodies various TWT signaling methods to facilitate efficient exchange of the TWT scheduling parameters and power capabilities information between a STA MLD 312 and an AP MLD 302.

In various embodiments, the power-controlled multi-link operation method provides a method to minimize the adverse effects of IDC interference, while maintaining as many possible benefits and inherent advantages of the STR multi-link operations, which include maximizing throughput and minimizing latency. More specifically, the various embodiments adapt the transmission power values for the overlapped scheduled SPs over the interfering links to values that minimize the adverse effects of IDC interference, based on the frequency gaps between the affiliated STAs, the presence of the IDC interference, and dynamic changes in the network.

The enhanced latency performance and interference management makes STR mode highly advantageous for scenarios requiring stringent timing and reliability, for example in scenarios where it is not possible to eliminate IDC through scheduling SPs at different times.

In various embodiments, the power-controlled multi-link operation method may be used in various wireless communication systems and devices such as WI-FI® AP MLDs 302 and STA MLDs 312 with multi-link (such as multi-band and/or multi-channel) capability and power saving capabilities, for example, WI-FI® 8 MLDs 302 and STA MLDs 312. Accordingly, the power-controlled multi-link operation method may be suitable for the standardization of next generation of IEEE 802.11bn for MLO.

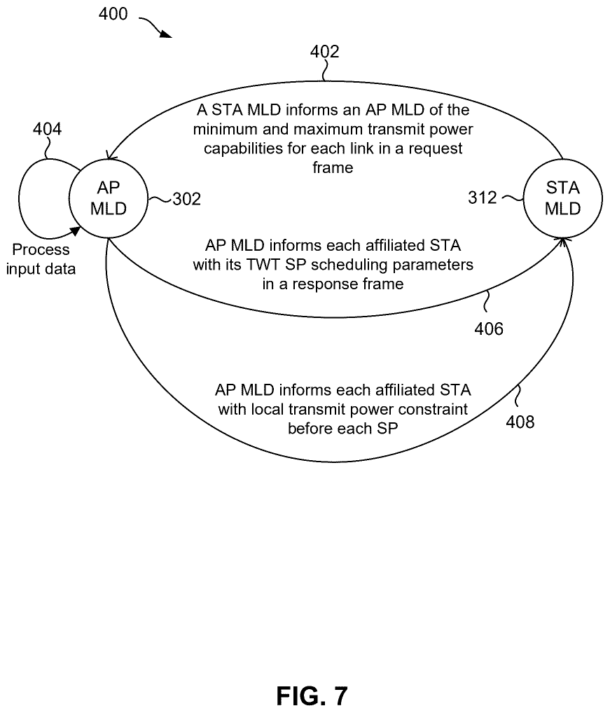

FIG. 7 is a schematic diagram showing the power-controlled multi-link operation method 400, according to some embodiments of this disclosure. In these embodiments, the power-controlled multi-link operation method 400 adapts the transmission power to values that minimize the IDC interference in STR MLO.

As shown, a STA MLD 312 (also denoted as a TWT requesting STA MLD 312) can select or otherwise obtain a minimum transmit power capability for each affiliated STA 112 to ensure reliable communication, wherein various factors such as channel conditions, distance, device characteristics, and/or the like may be taken into account. The TWT requesting STA MLD 312 can also select or otherwise obtain a maximum transmit power capability based on, for example, the regulatory requirements and/or hardware device capabilities.

During a TWT setup or resetup process, when the TWT requesting STA MLD 312 is associating or reassociating with an AP MLD 302 (also denoted as a TWT responding AP MLD 302), the TWT requesting STA MLD 312 sends or otherwise informs (402) the TWT responding AP MLD 302 of the minimum and maximum transmit power capabilities for each affiliated STA 112-1, 112-2, 112-3. The minimum and maximum transmit power capabilities for each affiliated STA 112-1, 112-2, 112-3 can be sent along with corresponding desired TWT scheduling parameters, through a (re)association request frame 400 sent from the STA MLD 312 to the AP MLD 312.

The TWT responding AP MLD 302 processes (404) the received desired TWT scheduling parameters of all affiliated STAs 112-1, 112-2, 112-3. Once both the TWT requesting STA MLD 312 and TWT responding AP MLD 302 reach acceptable TWT agreements for all links, the TWT responding AP MLD 302 can inform (406) each affiliated STA 112-1, 112-2, 112-3 with its TWT SP scheduling parameters.

At the TWT responding AP MLD 302, the TWT responding AP MLD 302 also processes (404) the received minimum and maximum transmit power capabilities of the affiliated STAs 112 of the TWT requesting STA MLD 312 to obtain the local maximum transmit power constraint for each affiliated STA 112 based on the frequency gap(s) between the affiliated STAs 112 and the presence of the IDC interference.

Before the start of each scheduled SP, the TWT responding AP MLD 302 informs (408) a corresponding affiliated STA 112 of the TWT requesting STA MLD 312 a local transmit power constraint for the scheduled SP. The local transmit power constraint (e.g., a local maximum transmit power constraint) for each scheduled SP that can minimize IDC interference can be determined using a power-controlled TWT algorithm that takes into account the frequency gap between affiliated STAs and the presence of IDC interference over the scheduled SPs.

In various embodiments, the power-controlled multi-link operation method introduces a modified TWT information frame (denoted as “a power-controlled TWT information frame”) used to specify the local transmit power constraint. The power-controlled TWT information frame is sent from the TWT responding AP MLD 302 to the affiliated STA 112 before the start of each scheduled SP, so the affiliated STA 112 knows the proper transmission power to use.

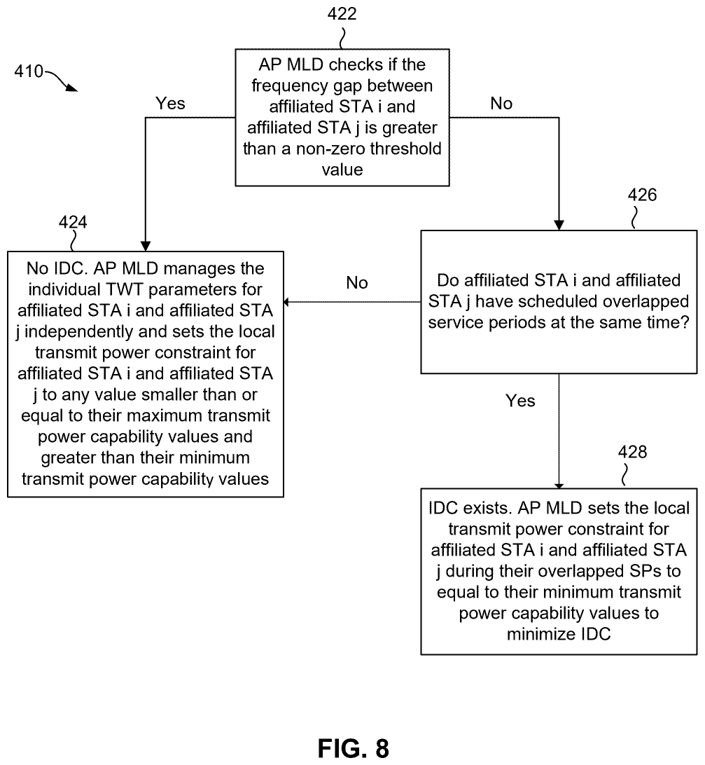

FIG. 8 is a schematic diagram showing the details of the power-controlled TWT algorithm 410, according to some embodiments of this disclosure.

At step (422), the TWT responding AP MLD 302 checks if a frequency gap between the i-th affiliated STA 112-i of the TWT requesting STA MLD 312 and the j-th affiliated STA 112-j of the TWT requesting STA MLD 312 is greater than a predefined or predetermined non-zero threshold value.

If the frequency gap between the two affiliated STAs 112-i and 112-j is greater than a predefined or predetermined non-zero threshold value, there would be no IDC. The TWT responding AP MLD 302 can manage the individual TWT parameters for affiliated STA 112-i and affiliated STA 112-j independently and sets the local transmit power constraints for the i-th affiliated STA 112-i and the j-th affiliated STA 112-j during their SPs to any values smaller than or equal to their corresponding maximum transmit power capability values, for example, any values between their minimum transmit power capability values and their maximum transmit power capability values (step 424).

In these embodiments, the local transmit power constraint for an affiliated STA 112 is an upper limit of the transmission power that the affiliated STA 112 shall use. In other words, the affiliated STA 112 may set its transmission power to any value between its minimum transmit power capability value and the received local transmit power constraint value.

At step (424), the TWT responding AP MLD 302 may set the local transmit power constraints for the i-th affiliated STA 112-i and the j-th affiliated STA 112-j to their maximum transmit power capability values if there are no other interference sources in the network. Otherwise, the TWT responding AP MLD 302 may set the local transmit power constraints for the i-th affiliated STA 112-i and the j-th affiliated STA 112-j to values greater than their minimum transmit power capability values, and smaller than or equal to their maximum transmit power capability values, based on the presence of other interference sources or for power consumption savings.

If, at step (422), the TWT responding AP MLD 302 determines that the frequency gap between the two affiliated STAs 112-i and 112-j is smaller than or equal to a predefined or predetermined non-zero threshold value, the TWT responding AP MLD 302 then checks at step (426) if the two affiliated STAs 112-i and 112-j have any scheduled overlapped SP(s) at the same time.

If the frequency gap between the two affiliated STAs 112-i and 112-j is smaller than or equal to the predefined or predetermined non-zero threshold value and the two affiliated STAs 112-i and 112-j have one or more scheduled overlapped SP(s) at the same time, the TWT responding AP MLD 302 sets the local transmit power constraints for the i-th affiliated STA 112-i and the j-th affiliated STA 112-j to their minimum transmit power capability values for each of the one or more scheduled overlapped SP(s) in order to minimize IDC.

If alternatively, the frequency gap between the two affiliated STAs 112-i and 112-j is smaller than or equal to the predefined or predetermined non-zero threshold value but the two affiliated STAs 112-i and 112-j do not have any scheduled overlapped SP(s) at the same time, the method (410) will revert to step (424), where the TWT responding AP MLD 302 can manage the individual TWT parameters for affiliated STA 112-i and affiliated STA 112-j independently and set the local transmit power constraints for the i-th affiliated STA 112-i and the j-th affiliated STA 112-j during their SPs to any values smaller than or equal to their corresponding maximum transmit power capability values and larger than their respective minimum transmit power capability values.

Unlike previous methods that schedule the overlapped interfering SPs/transmissions at different times, the power-controlled multi-link operation method as described herein enable simultaneous uplink and downlink transmissions during the overlapped interfering SPs over the IDC-impacted links by managing IDC interference through adjusting the transmission power values for the scheduled SPs over the affected links.

STR multi-link operation offers the ability to maximize throughput and minimize latency. The various embodiments therefore maintain as many of the benefits of STR while managing IDC interference, which is a significant improvement over existing solutions that often require scheduling the overlapped interfering SPs at different times, compromising on throughput and latency.

The described embodiments are particularly beneficial for delay-sensitive applications such as IoT devices and online gaming, where the latency and delay requirements are stringent, or when scheduling the overlapped interfering SPs at different times as done in existing solutions might simply not be feasible.

### C. Signaling Target Wake Time Scheduling Parameters and Power Capabilities Information

As those skilled in the art understand, in IEEE 802.11, management frames such as (re)association request frames and (re)association response frames are used by AP/non-AP MLDs for performing supervisory functions such as joining and leaving wireless networks and moving associations from one AP to another AP. A management frame generally comprises a plurality of information elements, including one or more TWT elements.

The power-controlled multi-link operation method (400) may use any suitable signaling method for efficient exchange of TWT scheduling parameters and power capabilities/constraint information between the TWT responding AP MLD 302 and TWT requesting STA MLD 312.

In some embodiments, the power-controlled multi-link operation method introduces a multi-link power capability element to include the transmit power capabilities for each link in order to provide an IDC-aware multi-link power control.

In some alternative embodiments, the power-controlled multi-link operation method introduces a power-controlled TWT element to include the transmit power capabilities for each link in order to provide the IDC-aware multi-link power control.

In some embodiments, the power-controlled multi-link operation method introduces a power-controlled TWT information frame to provide the local transmit power constraint for the affiliated STA 112 to the STA MLD 312 before each scheduled SP.

Thus, the transmission power on the interfering links may be adapted to values that minimize the adverse effects of IDC interference while maintaining the advantages of multi-link STR operation, making it suitable for delay-sensitive applications.

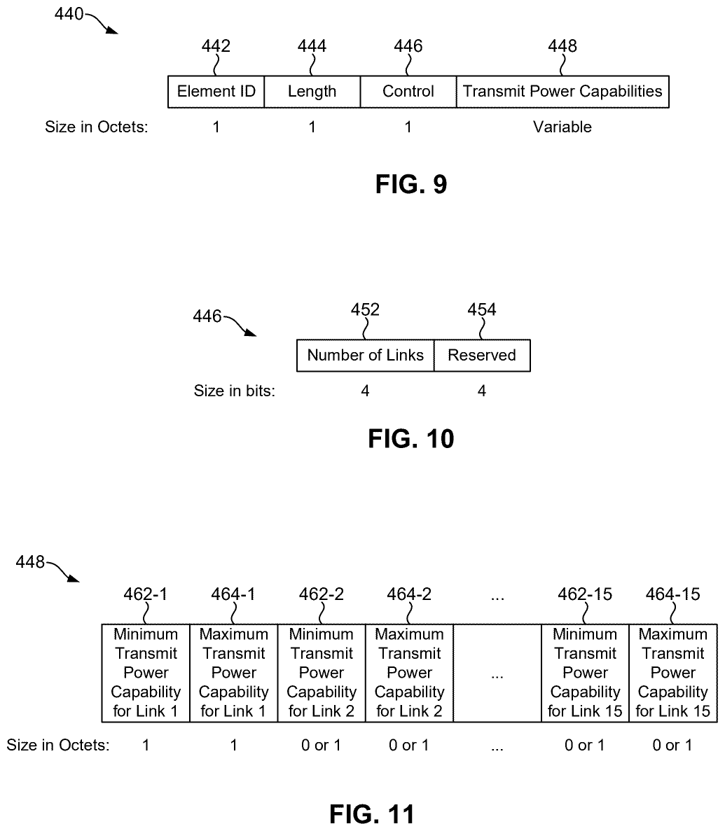

Embodiments are described below, by way of example only, with reference to FIGS. 9-23.

Referring back to FIG. 7, a TWT requesting STA MLD 312 that initiates an TWT (re)setup with a TWT responding AP MLD 302, informs (402) the TWT responding AP MLD 302 of the desired TWT parameters as well as the minimum and maximum transmit power capabilities for the current channel over each affiliated STA 112 when associating or reassociating.

In some embodiments, the desired TWT parameters for the current channel over each affiliated STA can be transmitted from the TWT requesting STA MLD 312 to the TWT responding AP MLD 302 through one or more TWT elements according to IEEE P802.11-REVme/D5.0-9.4.2.198 included in the (re)association request frame that the TWT requesting STA MLD 312 sends.

In some embodiments, the power-controlled multi-link operation method 400 also introduces a multi-link power capability element in the (re)association request frame for specifying a minimum and maximum transmit power capabilities for the current channel over each affiliated STA. In these embodiments, the power-controlled multi-link operation method 400 extends the power capability element according to IEEE P802.11-REVme/D5.0-9.4.2.13 to the MLO scenarios to indicate links to which the power control operation applies.

FIG. 9 shows the structure of the multi-link power capability element 440 of the (re)association request frame for MLO. As shown, the multi-link power capability element 440 comprises a one-byte element ID 442, a one-byte length field 444, a one-byte control field 446, and a transmit power capabilities field 448 of a variable length. As a comparison, the power capability element of a previous (re)association request frame is generally for single-link operations, and comprises a one-byte element ID, a one-byte length field, a one-byte minimum transmit power field, and a one-byte maximum transmit power field. Therefore, the power capability element of the previous (re)association request frame is not suitable for MLO.

FIG. 10 shows the structure of the control field 446 of the multi-link power capability element 440. In these embodiments, the control field 446 comprises a four-bit number of links subfield 452. The other four bits 454 are reserved or not used.

The number of links subfield 452 indicates the number of links specified in the transmit power capabilities field 448. Table 1 provides the meaning of the number of links subfield 452. For example, the number of links subfield 452 set to value zero (0) indicates that the transmit power capabilities field 448 only specifies the minimum and maximum transmit power capabilities of one link (that is, Link 1). As another example, the number of links subfield 452 set to value 14 indicates that the transmit power capabilities field 448 specifies the minimum and maximum transmit power capabilities of 15 links (that is, Link 1 to Link 15).

TABLE 1
MEANING OF THE NUMBER OF LINKS SUBFIELD
IN MULTI-LINK POWER CAPABILITY ELEMENT.

| | Subfields Present in the Transmit |
|---|---|
| Value | Power Capabilities Field 448 |
| 0 | Minimum Transmit Power Capability for Link 1 |
| | Maximum Transmit Power Capability for Link 1 |
| 1 | Minimum Transmit Power Capability for Link 1 |
| | Maximum Transmit Power Capability for Link 1 |
| | Minimum Transmit Power Capability for Link 2 |
| | Maximum Transmit Power Capability for Link 2 |
| . . . | . . . |
| 14 | Minimum Transmit Power Capability for Link 1 |
| | Maximum Transmit Power Capability for Link 1 |
| | . . . |
| | Minimum Transmit Power Capability for Link 15 |
| | Maximum Transmit Power Capability for Link 15 |
| 15 | Reserved |

FIG. 11 is a schematic diagram showing the structure of the transmit power capabilities field 448 of the (re)association request frame, which in these embodiments comprises one or more byte-pairs for one or more links, wherein each byte-pair comprises a one-byte subfield 462 indicating the minimum transmit power capability and another one-byte subfield 464 indicating the maximum transmit power capability of the respective link. Thus, the transmit power capabilities field 448 in these embodiments may be used for specifying the minimum and maximum transmit power capabilities of a minimum of one link (wherein the transmit power capabilities field 448 has a length of two bytes) and a maximum of 15 links (wherein the transmit power capabilities field 448 has a length of 30 bytes).

In these embodiments, the minimum and maximum transmit power capability subfields 462 and 464 for each link are set to the nominal minimum and maximum transmit powers, respectively, with which the STA is capable of transmitting in the current channel, with a tolerance of, for example, ±5 decibels (dB). The field is coded as a two's complement signed integer in units of decibels relative to one (1) milliwatts (mW).

Herein, “nominal” refers to the standard or expected values of the minimum and maximum transmit powers that the affiliated STA 112 is capable of transmitting on the current channel. These values are defined under typical conditions and are subject to a specified tolerance.

For example, “nominal minimum power” refers to the standard or usual lowest power level the affiliated STA 112 can transmit at in the given channel. It may not represent the absolute minimum power possible, and rather is the recommended or most common starting point.

Similarly, “nominal maximum power” refers to the standard or usual highest power level the affiliated STA 112 can transmit at in the channel. It may not be the absolute maximum power possible, and rather is the recommended limit for that specific channel.

In some embodiments, the minimum transmit power capability can be selected by the STA MLD 312 for each affiliated STA 112 to ensure reliable communication. Various factors such as channel conditions, distance, and device characteristics can be taken into account for the selection; whereas the maximum transmit power capability can be selected based on the regulatory regulations for each band and/or hardware device capabilities.

Referring back to FIG. 7, once both the TWT requesting STA MLD 312 and TWT responding AP MLD 302 reach acceptable TWT agreements for all links 330-1, 330-2, 330-3, the TWT responding AP MLD 302 informs (406) each affiliated STA 112 with its TWT SP scheduling parameters.

In some embodiments, the TWT SP scheduling parameters can be transmitted through one or more TWT elements according to IEEE P802.11-REVme/D5.0-9.4.2.198 in the (re)association response frame the TWT responding AP MLD 302 transmits.

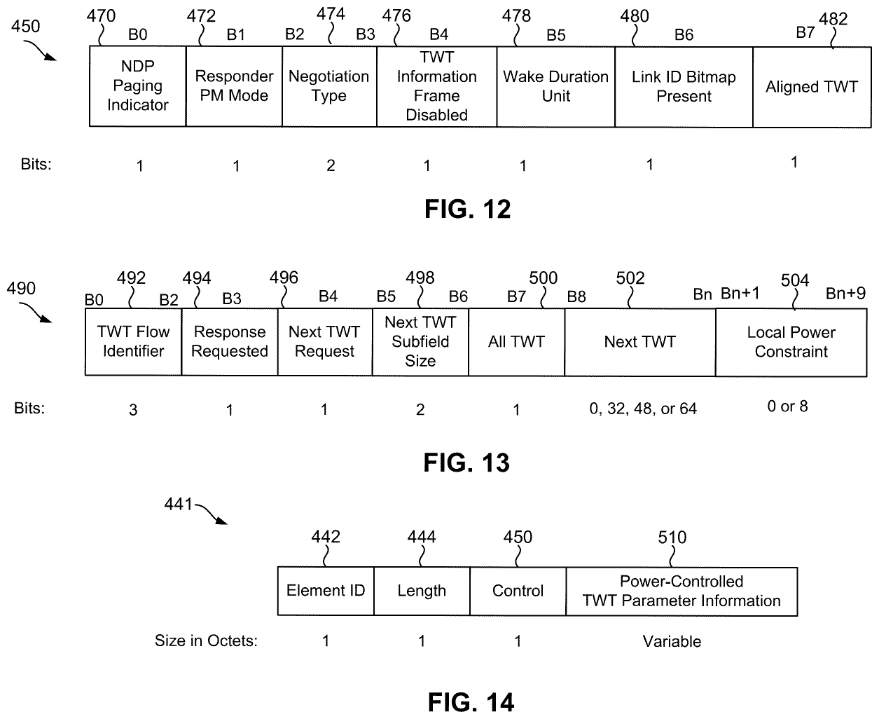

FIG. 12 is a schematic diagram of the structure of a control field 450 in a TWT element according to IEEE P802.11-REVme/D5.0-9.4.2.198.

The control field 450 of the TWT element comprises a one-bit near-data processing (NDP) paging indicator subfield 470, a one-bit responder PM mode subfield 472, a two-bit negotiation type subfield 474, a one-bit TWT information frame disabled subfield 476, a one-bit wake duration unit subfield 478, a one-bit link identification (ID) bitmap present subfield 480 and a one-bit aligned TWT subfield 482.

The NDP paging indicator subfield 470, the responder PM mode subfield 472, the negotiation type subfield 474, the TWT information frame disabled subfield 476, the wake duration unit subfield 478, the link ID bitmap present subfield 480 and the aligned TWT subfield 482 follow the format of a TWT element as defined according to IEEE P802.11-REVme/D5.0-9.4.2.198.

According to some embodiments, in order to enable the TWT responding AP MLD 302 to update the local transmit power constraint for each affiliated STA 112 before the start of each scheduled SP, the value of the TWT information frame disabled subfield 476 of the TWT element is set to a predetermined value to indicate that reception of TWT information frames or power-controlled TWT information frames (as will be described in more detail below) is enabled by one or more of the corresponding affiliated STAs 112. For example, the TWT information frame disabled subfield 476 of the TWT element is set to zero (0) to indicate that reception of TWT information frames or power-controlled TWT information frames is enabled by the one or more of the corresponding affiliated STAs 112.

Referring to FIG. 7, before the start of each scheduled SP, the TWT responding AP MLD 302 obtains appropriate local transmit power constraints for transmissions to be used during that period and informs (408) a corresponding affiliated STA 112 of the TWT requesting STA MLD 312 the local transmit power constraint for the corresponding scheduled SP.

In some embodiments, the TWT responding AP MLD 302 uses the agreed TWT parameters and the minimum and maximum transmit power capability for the affiliated STAs as inputs into the power-controlled TWT algorithm (described with reference to FIG. 8), in order to determine or otherwise obtain the local maximum transmit power constraints for the scheduled SPs over the corresponding links, based on the frequency gap between the affiliated STAs and the presence of the IDC interference over the scheduled SPs.

In an explicit TWT agreement (e.g., when an implicit subfield is set to zero (0) in a corresponding TWT element), an affiliated STA 112 can receive one or more TWT information frames according to IEEE P802.11-REVme/D5.0-9.4.1.58 informing them about the start time of the next TWT SPs. Alternatively or additionally, the affiliated STA 112 can receive one or more power-controlled TWT information frames informing about the appropriate local transmit power constraints for transmission to use during the next TWT SPs for its affiliated STA 112 as well as the start time of next TWT SPs.

In various embodiments, a power-controlled TWT information frame (alternatively denoted as “an Ultra-High Reliability (UHR) TWT information frame”) is introduced that follows the format of a TWT information frame according to IEEE P802.11-REVme/D5.0-9.6.24.12, but modified to provide the appropriate local transmit power constraint to the affiliated STA.

In these embodiments, the local transmit power constraint (e.g., a local maximum transmit power constraint) for each scheduled SP is specified in a power-controlled TWT information field of the power-controlled TWT information frame, sent from the TWT responding AP MLD 302 to the affiliated STA 112, so the affiliated STA 112 knows the proper transmission power to use.

An action field of the power-controlled TWT information frame contains the information shown in following Table:

TABLE 2
Power-Controlled TWT Information Frame Action Field Format

| Order | Information |
|---|---|
| 1 | Catogory as defined in IEEE P802.11-REVme/D5.0 - 9.4.1.11 |
| 2 | Unprotected S1G Action |
| 3 | Power-controlled TWT Information Field |

In the explicit mode (e.g., when an implicit subfield is set to zero (0) in a corresponding TWT element), the power-controlled TWT information frame is sent by the TWT responding AP MLD 302 to deliver information about the appropriate local transmit power constraint for use during the next TWT SP period as well as the start time of next TWT SP. The power-controlled TWT information frame is transmitted to an affiliated STA 112 that has indicated support of its reception. For example, the power-controlled TWT information frame is transmitted to an affiliated STA 112 which has specified in the TWT information frame disabled subfield 476 as enabling the reception of the power-controlled TWT information frame (e.g., the TWT information frame disabled subfield 476 of the TWT element is set to zero (0)).

In some embodiments, the unprotected sub-1-GHz (S1G) action field according to IEEE P802.11-REVme/D5.0-9.6.24.1 is modified to repurpose a reserved value to represent the power-controlled TWT information frame. As shown in Table 3, value twelve (12) is repurposed to represent the power-controlled TWT information frame. It can be understood that other reserved value (e.g., any value from thirteen (13) to two hundred and fifty-five (255)) may be repurposed to represent the power-controlled TWT information frame instead of twelve (12).

TABLE 3
Modified Unprotected S1G Action field values

| Value | Meaning |
|---|---|
| 0 | AID Switch Request |
| 1 | AID Switch Response |
| 2 | Sync Control |
| 3 | STA Information Announcement |
| 4 | EDCA Parameter Set |
| 5 | EL Operation |
| 6 | TWT Setup |
| 7 | TWT Teardown |
| 8 | Sectorized Group ID List |
| 9 | Sector ID Feedback |
| 10 | Reserved |
| 11 | TWT information |
| 12 | Power-Controlled TWT information |
| 13-255 | Reserved |

As shown in Table 2, the power-controlled TWT information frame comprises a power-controlled TWT information field which is used to specify the local transmit power constraint for each scheduled SP.

According to some embodiments, the power-controlled multi-link operation method introduces a power-controlled TWT information field which is based on the TWT information field according to IEEE P802.11-REVme/D5.0-9.4.1.58, but modified to include not just the start time of the next scheduled TWT SP, but also the local transmit power constraint to be used during that SP.

FIG. 13 shows a structure of the power-controlled TWT information field 490 of a power-controlled TWT information frame according to some embodiments of the disclosure.

The power-controlled TWT information field 490 comprises a three-bit TWT flow identifier subfield 492, a one-bit response requested subfield 494, a one-bit next TWT request subfield 496, a two-bit next TWT subfield size subfield 498, a one-bit all TWT subfield 500, a next TWT subfield 502 and a local power constraint subfield 504. The next TWT subfield 502 can be of zero (0), thirty-two (32), forty-eight (48), or sixty-four (64) bits. The local power constraint subfield 504 can be zero (0) or eight (8) bits, depending on whether local power constraint values are included.

The TWT flow identifier subfield 492, the response requested subfield 494, the next TWT request subfield 496, the next TWT subfield size subfield 498, the all TWT subfield 500, and the next TWT subfield 502 are the same as those specified according to IEEE P802.11-REVme/D5.0-9.4.1.58. The local power constraint subfield 504 specifies the local transmit power constraint to be used during a SP for the corresponding affiliated STA 112.

In some embodiments, the value of the response requested subfield 494 is set to a predetermined value (e.g., zero (0)) to indicate that no response is required from the affiliated STA 112 after receiving the power-controlled TWT information frame.

As described with reference to Table 2, Table 3, and FIGS. 12-13, using the power-controlled TWT information frame, the TWT responding AP MLD 302 can inform (408) a corresponding affiliated STA 112 of the TWT requesting STA MLD 312 the local transmit power constraint for the corresponding scheduled SP before the start of each scheduled SP.

In some embodiments, the power-controlled multi-link operation method 400 introduces and uses one or more power-controlled TWT elements included in a (re)association request frame and a re(association) response frame for exchanging the TWT scheduling parameters and power capabilities information.

According to these embodiments, the TWT scheduling parameters and power capabilities information can be signaled using one or more power-controlled TWT elements to minimize frame size and signaling overhead.

Referring again to FIG. 7, a TWT requesting STA MLD 312 that initiates an TWT (re)setup with a TWT responding AP MLD 302, informs (402) the TWT responding AP MLD 302 of the desired TWT parameters as well as the minimum and maximum transmit power capabilities for the current channel over each affiliated STA 112 when associating or reassociating.

In some embodiments, the desired TWT parameters as well as the minimum and maximum transmit power capabilities for the current channel over each affiliated STA can be transmitted from the TWT requesting STA MLD 312 using one or more power-controlled TWT elements included in a (re)association request frame the TWT requesting STA MLD 312 transmits.

According to these embodiments, the power-controlled TWT element is introduced which is a TWT element according to IEEE P802.11-REVme/D5.0-9.4.2.13 and IEEE P802.11be/D5.0-9.4.2.198 but reformulated to incorporate transmission power capabilities information within its control field and a newly introduced TWT parameter information field (denoted as “power-controlled TWT parameter information field”). This modification can facilitate an efficient exchange of transmission power information between the TWT requesting STA MLD 312 and the TWT responding AP MLD 302 for each service period, thereby reducing the effects of IDC interference.

FIG. 14 is a schematic diagram of the structure of a power-controlled TWT element 441 according to some embodiments of this disclosure. The power-controlled TWT element 441 comprises a one-byte element ID field 442, a one-byte length field 444, a one-byte control field 450, and a power-controlled TWT parameter information field 510 (sometimes denoted as a “TWT parameter information field 510” for simplification) of a variable length. The element ID field 442 and the length field 444 are the same as those in a TWT element specified according to IEEE P802.11-REVme/D5.0-9.4.2.13 and IEEE P802.11be/D5.0-9.4.2.198.

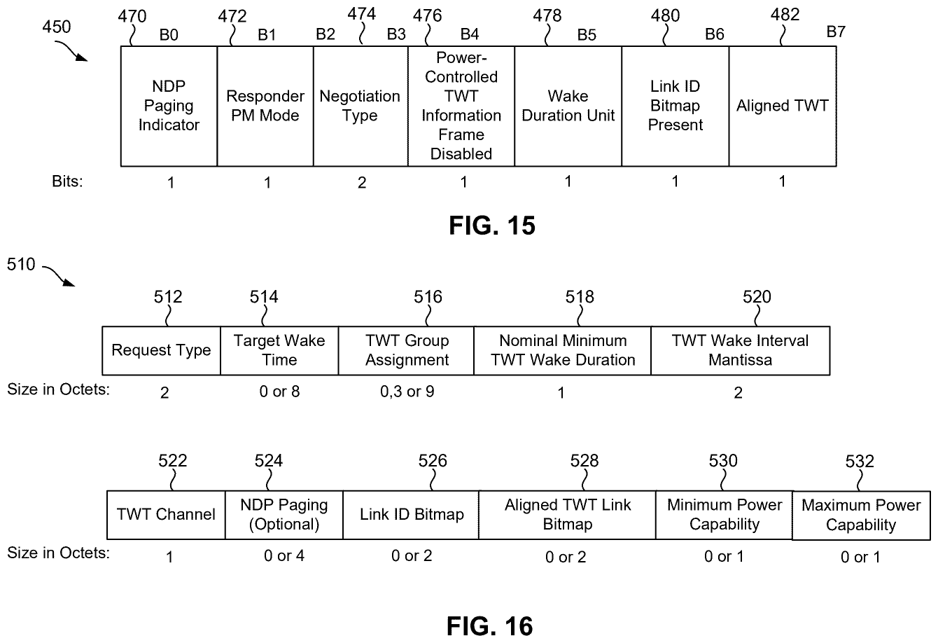

FIG. 15 shows a structure of the control field 450 of the power-controlled TWT element 441 according to some embodiments of this disclosure.

The control field 450 of the power-controlled TWT element 441 comprises a one-bit NDP paging indicator subfield 470, a one-bit responder PM mode subfield 472, a two-bit negotiation type subfield 474, a one-bit power-controlled TWT information frame disabled subfield 476, a one-bit wake duration unit subfield 478, a one-bit link ID bitmap present subfield 480 and a one-bit aligned TWT subfield 482. The NDP paging indicator subfield 470, the responder PM mode subfield 472, the negotiation type subfield 474, the wake duration unit subfield 478, the link ID bitmap present subfield 480 and the aligned TWT subfield 482 are the same as those specified according to IEEE P802.11-REVme/D5.0-9.4.2.13 and IEEE P802.11be/D5.0-9.4.2.198. The power-controlled TWT information frame disabled subfield 476 is similar to a TWT information frame disabled subfield as specified according to IEEE P802.11-REVme/D5.0-9.4.2.13 and IEEE P802.11be/D5.0-9.4.2.198 and is used to indicate the ability of transmitting or receiving one or more power-controlled TWT information frame(s).

FIG. 16 shows a structure of the individual TWT parameter information field 510 of the power-controlled TWT element 441 according to some embodiments of this disclosure.

The TWT parameter information field 510 of the power-controlled TWT element 441 comprises a two-byte request type subfield 512, a zero or eight-byte target wake time subfield 514, a zero, three or nine-byte TWT group assignment subfield 516, a one-byte nominal minimum TWT wake duration subfield 518, a two-byte TWT wake interval mantissa subfield 520, a one-byte TWT channel subfield 522, an optional zero or four-byte NDP paging subfield 524, a zero or two-byte link ID bitmap subfield 526, and a zero or two-byte aligned TWT link bitmap subfield 528. The request type 512, target wake time subfield 514, the TWT group assignment subfield 516, the nominal minimum TWT wake duration subfield 518, the TWT wake interval mantissa subfield 520, the TWT channel subfield 522, the optional NDP paging subfield 524, the link ID bitmap subfield 526, and the aligned TWT link bitmap subfield 528 are the same as those specified according to IEEE P802.11-REVme/D5.0-9.4.2.13 and IEEE P802.11be/D5.0-9.4.2.198.

Different from the existing methods, the TWT parameter information field 510 of the power-controlled TWT element 441 further comprises at least one pair of a zero or one-byte minimum power capability subfield 530 and a zero or one-byte maximum power capability subfield 532. If included, the minimum power capability subfield 530 is set to specify the minimum power capability value of an affiliated STA 112, and the maximum power capability subfield 532 is set to specify the maximum power capability value of the corresponding affiliated STA 112.

If the power-controlled TWT element 441 is associated with more than one affiliated STA 112, more than one minimum power capability subfield 530 and maximum power capability subfield 532 byte-pair can be included, wherein each byte-pair comprises a one-byte subfield 530 indicating the minimum transmit power capability and another one-byte subfield 532 indicating the maximum transmit power capability of the respective link. In such cases, the link ID bitmap subfield 526 can be used to indicate the number of links specified in the TWT parameter information field 510.

In this structure, “optional” means that the TWT parameter information field 510 may or may not include the NDP paging subfield 524 depending on the situation, which is indicated by the NDP paging indicator 470.

In some embodiments, the minimum and maximum transmit power capability subfields 530 and 532 for each link are set to the nominal minimum and maximum transmit powers, respectively, with which the STA is capable of transmitting in the current channel, with a tolerance of, for example, ±5 decibels (dB). The field is coded as a two's complement signed integer in units of decibels relative to one (1) milliwatts (mW).

Herein, “nominal” refers to the standard or expected values of the minimum and maximum transmit powers that the affiliated STA 112 is capable of transmitting on the current channel. These values are defined under typical conditions and are subject to a specified tolerance.

For example, “nominal minimum power” refers to the standard or usual lowest power level the affiliated STA 112 can transmit at in the given channel. It may not represent the absolute minimum power possible, and rather is the recommended or most common starting point.

Similarly, “nominal maximum power” refers to the standard or usual highest power level the affiliated STA 112 can transmit at in the channel. It may not be the absolute maximum power possible, and rather is the recommended limit for that specific channel.

In some embodiments, the minimum transmit power capability can be selected by the STA MLD 312 for each affiliated STA 112 to ensure reliable communication. Various factors such as channel conditions, distance, and device characteristics can be taken into account for the selection.

In some embodiments, the maximum transmit power capability can be selected based on the regulatory regulations for each band and/or hardware device capabilities.

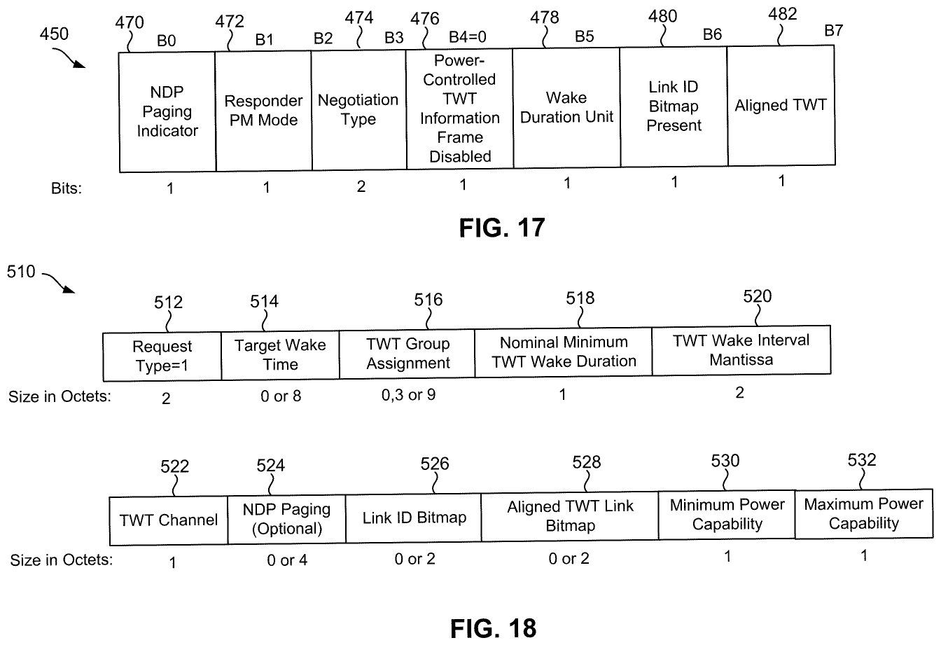

FIG. 17 is a schematic diagram showing a first example of the control field 450 of the power-controlled TWT element 441, when the power-controlled TWT information frame disabled subfield 476 is set to zero (0); and FIG. 18 is a schematic diagram showing the first example of the power-controlled TWT parameter information field 510 of the power-controlled TWT element 441, when the request type subfield 512 is set to one (1).

If a power-controlled TWT element 441 is sent by a TWT requesting STA 312, the value of the request type subfield 512 is set to a predefined or predetermined value (e.g., one (1)). In this case, the value of power-controlled TWT information frame disabled subfield 476 indicates the capability of receiving power-controlled TWT Information frames 490 from the TWT responding AP MLD 302 as well as the presence of the affiliated STA 112's power capabilities in the TWT parameter information field 510.

More specifically, an affiliated STA 112 sets the power-controlled TWT information frame disabled subfield 476 to a predefined or predetermined value (e.g., zero (0)) if the affiliated STA 112 accepts receiving one or more power-controlled TWT information frame(s) 490 and the TWT parameter information field 510 includes the minimum and maximum power capabilities subfields 530, 532 for one or more of the corresponding links. In other words, the power-controlled TWT information frame disabled subfield 476 is set to zero (0) to indicate that reception of the power-controlled TWT information frame 490 is enabled and minimum and maximum power capabilities subfields 530, 532 specifying the minimum and maximum power capabilities of the affiliated STA(s) 112 are present in the TWT parameter information field 510. Otherwise, the TWT information frame disabled subfield 476 is set to one (1).

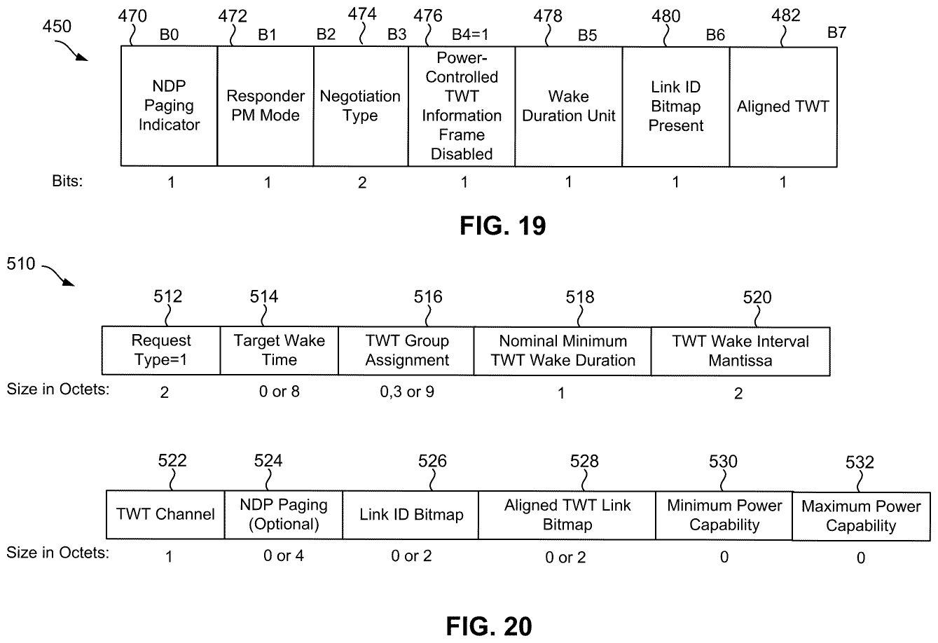

FIG. 19 is a schematic diagram showing a second example of the control field 450 of the power-controlled TWT element 441, when the power-controlled TWT information frame disabled subfield 476 is set to one (1); and FIG. 20 is a schematic diagram showing the second example of the power-controlled TWT parameter information field 510 of the power-controlled TWT element 441, when the request type subfield 512 is set to one (1).

When the request type subfield 512 is one (1) indicating a power-controlled TWT element 441 sent from a TWT requesting STA 312, and the power-controlled TWT information frame disabled subfield 476 is one (1), the TWT parameter information field 510 would not include any minimum power capability subfield 530 or maximum power capability subfield 532.

When a power-controlled TWT element 441 is sent by a TWT responding AP 302, the value of the request type subfield 512 can be set to another predefined or predetermined value (e.g., zero (0)). In this case, the value of power-controlled TWT information frame disabled subfield 476 indicates only the capability of the TWT responding AP MLD 302 sending power-controlled TWT information frames 490 (and/or the capability of the TWT requesting STA MLD 312 receiving power-controlled TWT information frames 490). In other words, no power capabilities information is included in the TWT parameter information field 510.

In some embodiments, an affiliated AP 102 sets the power-controlled TWT information frame disabled subfield 476 to zero (0) if the affiliated AP 102 accepts sending the power-controlled TWT information frame 490 (and/or the affiliated STA 112 accepts receiving the power-controlled TWT information frames 490). Otherwise, the TWT information frame disabled subfield 476 is set to one (1).

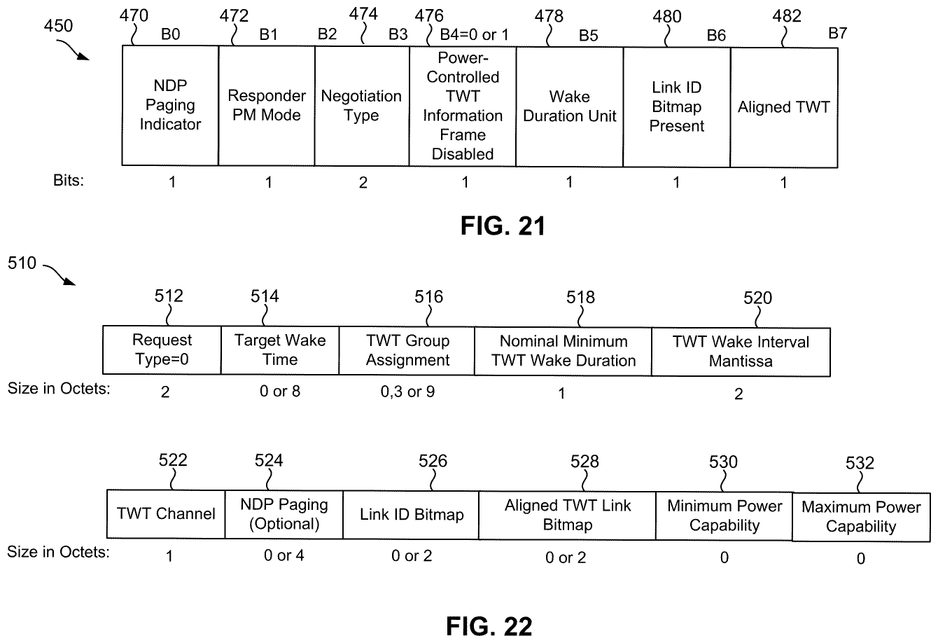

FIG. 21 is a schematic diagram showing a third example of the control field 450 of the power-controlled TWT element 441, when the power-controlled TWT information frame disabled subfield 476 is set to zero (0) or one (1); and FIG. 22 is a schematic diagram showing the third example of the power-controlled TWT parameter information field 510 of the power-controlled TWT element 441, when the request type subfield 512 is set to zero (0).

Since the request type subfield 512 is zero (0) indicating a power-controlled TWT element 441 sent from a TWT responding AP 302, the TWT parameter information field 510 would not include the minimum and maximum power capabilities of the affiliated STA 112 regardless of whether the power-controlled TWT information frame disabled subfield 476 is zero (0) or one (1).

Referring to step 406 of FIG. 7, once both the TWT requesting STA MLD 312 and TWT responding AP MLD 302 reach acceptable TWT agreements for all links 330-1, 330-2, 330-3, the TWT responding AP MLD 302 informs (406) each affiliated STA 112 with its TWT SP scheduling parameters.

In some embodiments, the TWT SP scheduling parameters are transmitted through one or more power-controlled TWT elements 441 in the (re)association response frame the TWT responding AP MLD 302 transmits.

In order to enable the TWT requesting STA MLD 312 to include its power capabilities into the TWT parameter information field 510, and for the TWT responding AP MLD 302 to update the local transmit power of each affiliated STA 112 before the start of each scheduled SP, the value of the power-controlled TWT information frame disabled subfield 476 in the control field 450 of the power-controlled TWT element 441 is set to zero (0).

Referring to FIG. 7, before the start of each scheduled SP over each link, the TWT responding AP MLD 302 can obtain appropriate local transmit power constraints for transmissions to be used during that period.

In some embodiments, the TWT responding AP MLD 302 uses the agreed TWT parameters and the minimum and maximum transmit power capability in the power-controlled TWT element 441 for the affiliated STAs 112 as inputs into the power-controlled TWT algorithm (described with reference to FIG. 8), in order to determine or otherwise obtain the local maximum transmit power constraint for the scheduled SPs over the corresponding links, based on the frequency gap between the affiliated STAs and the presence of the IDC interference over the scheduled SPs.

The TWT responding AP MLD 302 then notifies (408) a corresponding affiliated STA 112 of the TWT requesting STA MLD 312 a local transmit power constraint for the corresponding scheduled SP before the start of the SP.

Similar to the embodiments described above, the local transmit power constraint (e.g., a local maximum transmit power constraint) for each scheduled SP is specified in the power-controlled TWT information field 490 of the power-controlled TWT information frame, sent from the TWT responding AP MLD 302 to the affiliated STA 112, so the affiliated STA 112 knows the proper transmission power to use, as described above.

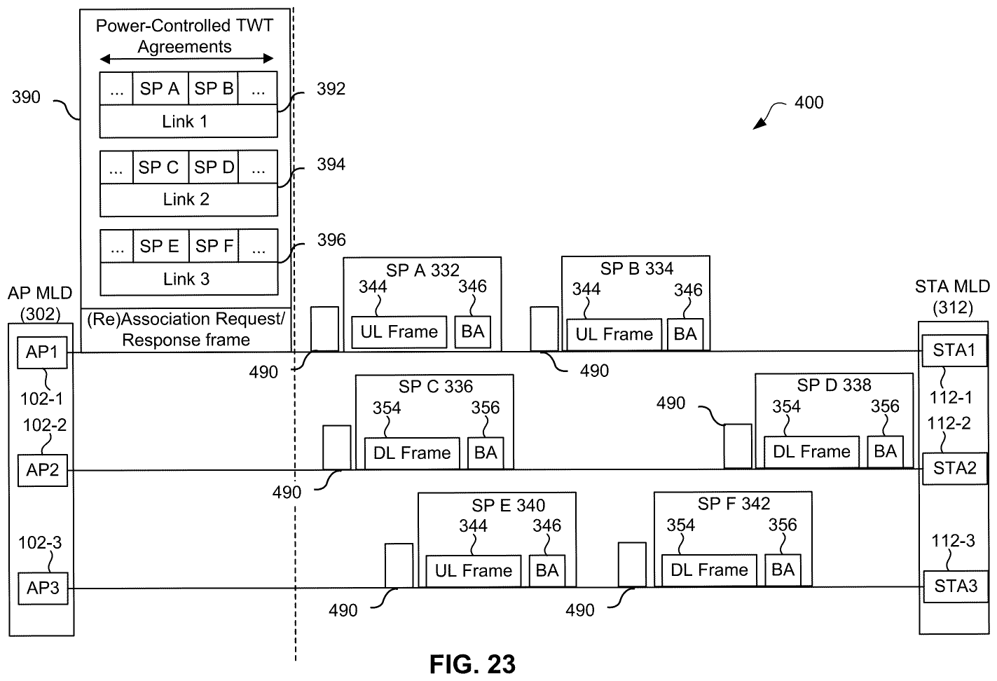

FIG. 23 shows a schematic diagram of the power-controlled multi-link operation method 400, according to some embodiments of the disclosure.

Referring to FIG. 23, the exchange of TWT scheduling parameters and power capabilities information can be performed through individual power-controlled TWT agreements 390 sent on a single link between AP1 102-1 and STA1 112-1. The power-controlled TWT agreements 390 can include one or more of the elements described in various embodiments.

As can be seen from FIG. 23, before each scheduled SP, the TWT responding AP MLD 302 sends a power-controlled TWT information frame 490 to the TWT requesting STA MLD 312 notifying the corresponding STA 112 of its local transmit power constraint so the STA 112 knows the appropriate local transmit power for use of its transmission.

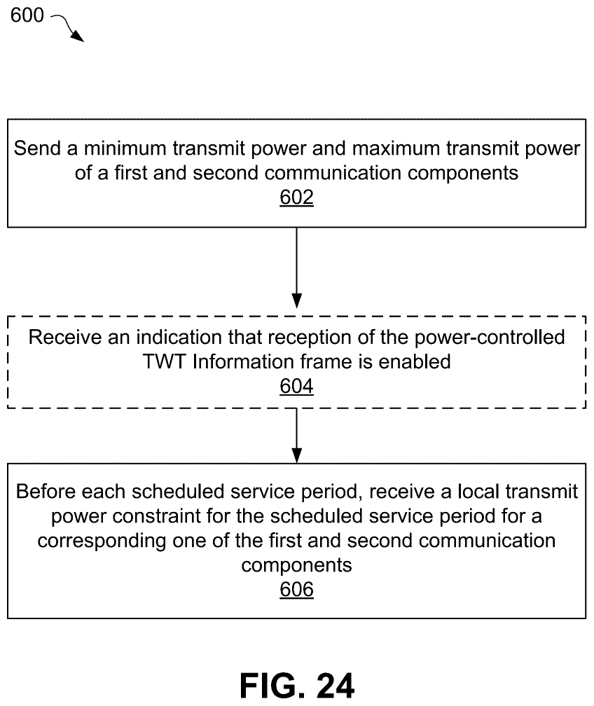

FIG. 24 is a flow chart of a first communication method (600) performed e.g., at the TWT requesting STA MLD 312, according to some embodiments of the disclosure.

The first communication method (600) starts by sending (602), from the MLD 312, a minimum transmit power and a maximum transmit power for each of at least a first communication link 330-1 and a second communication link 330-2 for use by at least a first communication component 112-1 and a second communication component 112-2 of the MLD 312, respectively. Before the start of a scheduled service period, the MLD 312 receives (606) a local transmit power constraint for the scheduled service period for a corresponding one of the first and second communication links 330-1, 330-2.

If a frequency gap between the first communication link 330-1 and the second communication link 330-2 is equal to or smaller than a threshold and if the scheduled service period overlaps with another scheduled service period for the other one of the first and second communication links, the local transmit power constraints for the first and second communication links are set to correspond to the respective minimum transmit powers.

In some embodiments, if the frequency gap between the first communication link and the second communication link is larger than the threshold, the local transmit power constraints for the first and second communication links 330-1, 330-2 can correspond to values smaller than or equal to the respective maximum transmit powers and greater than the respective minimum transmit powers.

Alternatively, if the frequency gap between the first communication link 330-1 and the second communication link 330-2 is equal to or smaller than the threshold but the scheduled service period does not overlap with another scheduled service period for the other one of the first and second communication links 330-1, 330-2, the local transmit power constraints for the first and second communication links 330-1, 330-2 can also correspond to values smaller than or equal to the respective maximum transmit powers and greater than the respective minimum transmit powers.

Before the MLD 312 receives (606) the local transmit power constraint, the MLD 312 may also receive (604) an indication that reception of the power-controlled TWT information frame 490 is enabled.

In some embodiments, the indication can be transmitted through an association response frame 390 containing a TWT element, where a TWT information frame disabled subfield 476 of the TWT element is set to a predetermined value (e.g., zero (0)) to indicate that reception of the power-controlled TWT information frame 490 is enabled by at least one of a plurality of communication components 112 of the MLD 312.

In some embodiments, the minimum and maximum transmit powers may be sent via a multi-link power capability element 440 included in an association request frame. The multi-link power capability element can comprise a control field 446 and a transmit power capabilities field 448 specifying the minimum and maximum transmit powers for each of the first and second communication links 330-1, 330-2. The control field 446 can comprise a number of links subfield 452 for indicating a number of a plurality of communication links specified in the transmit power capabilities field 448.

In some alternative embodiments, the minimum and maximum transmit powers can be sent by a first power-controlled TWT element 441 included in the association request frame. In these embodiments, the first power-controlled TWT element 441 comprises a power-controlled TWT parameter information field 510 specifying the minimum and maximum transmit powers for each of one or more of a plurality of communication components 112 of the MLD 312.

In some embodiments, the local transmit power constraint for the scheduled service period can be included in a power-controlled TWT information frame. The power-controlled TWT information frame can comprise an action field containing an unprotected S1G action subfield, and a predetermined value of the unprotected SIG action field can be used to represent a power-controlled TWT information frame. The local transmit power constraint can be included in a power-controlled TWT information field 490 of the power-controlled TWT information frame.

In some embodiments, the first power-controlled TWT element 441 can further comprise a control field 450 containing a power-controlled TWT information frame disabled subfield 476, where a value (e.g., zero (0)) of the power-controlled TWT information frame disabled subfield 476 can be used to indicate both a capability of receiving power-controlled TWT information frames and a presence of the minimum and maximum transmit powers for each of the one or more of the plurality of communication components 112 in the power-controlled TWT parameter information field 510.

In some embodiments, the indication that reception of the power-controlled TWT information frame is enabled can be received through a second power-controlled TWT element 441 included in an association response frame, where a power-controlled TWT information frame disabled subfield 476 of the second power-controlled TWT element 441 is set to a predetermined value (e.g., zero (0)) to indicate that reception of the TWT information frame is enabled.

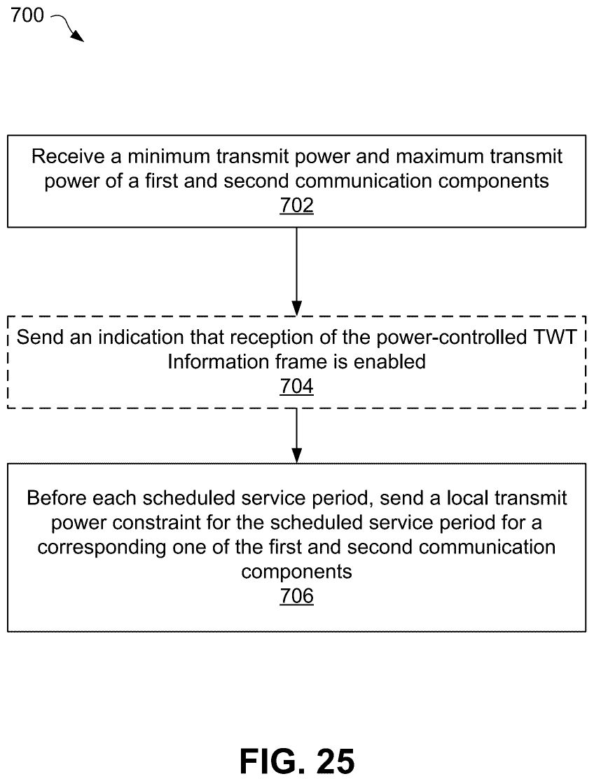

FIG. 25 is a flow chart of a second communication method (700) performed e.g., at the TWT responding AP MLD 302, according to some embodiments of the disclosure.

The second communication method starts by receiving (702), from the TWT requesting STA MLD 312, a minimum transmit power and a maximum transmit power for each of at least a first communication link 330-1 and a second communication link 330-1 for use by at least a first communication component 112-1 and a second communication component 112-2 of the MLD 312, respectively. Before the start of a scheduled service period, the TWT responding AP MLD 302 sends (706) a local transmit power constraint for the scheduled service period for a corresponding one of the first and second communication links 330-1, 330-2.

If a frequency gap between the first communication link 330-1 and the second communication link 330-2 is equal to or smaller than a threshold and if the scheduled service period overlaps with another scheduled service period for the other one of the first and second communication links, the local transmit power constraints for the first and second communication links 330-1, 330-2 are set to correspond to the respective minimum transmit powers.

In some embodiments, if the frequency gap between the first communication link and the second communication link is larger than the threshold, the local transmit power constraints for the first and second communication links 330-1, 330-2 can correspond to values smaller than or equal to the respective maximum transmit powers and greater than the respective minimum transmit powers.

Alternatively, if the frequency gap between the first communication link 330-1 and the second communication link 330-2 is equal to or smaller than the threshold but the scheduled service period does not overlap with another scheduled service period for the other one of the first and second communication links 330-1, 330-2, the local transmit power constraints for the first and second communication links 330-1, 330-2 can also correspond to values smaller than or equal to the respective maximum transmit powers and greater than the respective minimum transmit powers.

Before the MLD 302 sends (706) the local transmit power constraint, the MLD 302 may also send (704) an indication that reception of the power-controlled TWT Information frame 490 is enabled by one or more of the affiliated STA(s) 112.

In some embodiments, the indication can be transmitted through an association response frame 390 containing a TWT element, where a TWT information frame disabled subfield 476 of the TWT element is set to a predetermined value (e.g., zero (0)) to indicate that reception of the power-controlled TWT information frame 490 is enabled by at least one of a plurality of communication components 112 of the MLD 312.

In some embodiments, the minimum and maximum transmit powers may be received via a multi-link power capability element 440 included in an association request frame. The multi-link power capability element can comprise a control field 446 and a transmit power capabilities field 448 specifying the minimum and maximum transmit powers for each of the first and second communication links. The control field 446 can comprise a number of links subfield 452 for indicating a number of a plurality of communication links specified in the transmit power capabilities field 448.

In some alternative embodiments, the minimum and maximum transmit powers can be received via a first power-controlled TWT element 441 included in the association request frame. In these embodiments, the first power-controlled TWT element 441 comprises a power-controlled TWT parameter information field 510 specifying the minimum and maximum transmit powers for each of one or more of a plurality of communication components 112 of the MLD 312.

In some embodiments, the local transmit power constraint for the scheduled service period can be included in a power-controlled TWT information frame. The power-controlled TWT information frame can comprise an action field containing an unprotected S1G action subfield, and a predetermined value of the unprotected SIG action field can be used to represent a power-controlled TWT information frame. The local transmit power constraint can be included in a power-controlled TWT information field 490 of the power-controlled TWT information frame.

In some embodiments, the first power-controlled TWT element 441 can further comprise a control field 450 containing a power-controlled TWT information frame disabled subfield 476, where a value (e.g., zero (0)) of the power-controlled TWT information frame disabled subfield 476 can be used to indicate both a capability of receiving power-controlled TWT information frames and a presence of the minimum and maximum transmit powers for each of the one or more of the plurality of communication components in the power-controlled TWT parameter information field 510.

In some embodiments, the indication that reception of the power-controlled TWT information frame is enabled can be sent through a second power-controlled TWT element 441 included in an association response frame, where a power-controlled TWT information frame disabled subfield 476 of the second power-controlled TWT element 441 is set to a predetermined value (e.g., zero (0)) to indicate that reception of the TWT information frame is enabled by one or more of the affiliated STA(s) 112.

Herein, a power-controlled multi-link operation method 400 is disclosed, which is designed for managing IDC interference in multi-link STR operations. In some embodiments, the power-controlled multi-link operation method disclosed herein includes signaling methods to facilitate efficient exchange of TWT scheduling information and power information between AP and non-AP MLDs 302 and 312. In some embodiments, the power-controlled multi-link operation method disclosed herein uses an adaptive IDC-aware power-control TWT algorithm to adjust transmission power across multiple links, with consideration of various factors such as frequency separation between affiliated non-APs 112 and the presence of IDC interference, thereby enabling simultaneous uplink and downlink transmissions over IDC-impacted links while effectively managing the IDC interference.

As can be seen from the description above, the various embodiments provide a number of signaling approaches for the TWT scheduling parameters and power capabilities information exchange/update between AP/non-AP MLDs, including:
Signaling TWT scheduling parameters and power capabilities information through using TWT elements and multi-link power capability element 440, respectively, in some embodiments;
Signaling both the TWT scheduling parameters and power capabilities information through using power-controlled TWT elements 441 to minimize frame size and signaling overhead, in some alternative embodiments; and
Modifying the TWT information field 490 to include not just the start time of the next scheduled TWT period as in the legacy standard, but also the specific local transmit power constraint value for use during that period. This enables the TWT responding AP MLD 302 to update the local transmit power for each scheduled SP, based on the presence of the IDC interference.

These extended elements/frames represent significant enhancements in the management of multi-link TWT operations. The various embodiments of the IDC-aware power-controlled TWT method reduce the complexity involved in network management, significantly improving over previous methods which often involved complex orthogonal time scheduling, end-time alignment or TX/TX RX/RX operations synchronization.

In various embodiments, the power-controlled multi-link operation method disclosed herein addresses several problems in previous methods, such as:

Managing the IDC interference in STR MLO for overlapped scheduled SPs over interfering links: the IDC interference in STR MLOs can be managed and reduced over overlapped scheduled SPs without the need to reschedule the SPs at different times. The method disclosed herein dynamically adjusts transmission power for each scheduled SP based on frequency separation and interference conditions, allowing for continued efficient STR operation in the presence of IDC, thereby leading to a significant improvement over previous approaches that often require rescheduling overlapped SPs at different times.

Minimizing delay in MLO in the presence of IDC interference: previous methods often require rescheduling overlapped SPs over interfering links at different times, which compromises the throughput and latency. The method disclosed herein provides an IDC-aware power-controlled TWT mechanism that maintains as many of the inherent advantages of STR MLO, especially minimizing delay.

Providing feasible mechanisms for delay-sensitive applications: rescheduling overlapped SPs over interfering links at different times as in previous methods might not be feasible in time-sensitive communications scenarios like IoT operations and online gaming, where the delay requirements are stringent. By effectively managing IDC interference in STR MLO, the method disclosed herein allows STR MLO to operate efficiently for the overlapped SPs over interfering links in the presence of IDC interference, especially in delay-sensitive applications, satisfying their delay constraints.

Simplifying network management: by providing clear and measurable criteria for power control in the presence of IDC interference, the method disclosed herein simplifies network management compared to previous approaches that often relied on complex synchronization or scheduling mechanisms.

### D. Acronyms, Abbreviations, and Definition of Some Terms

| Full Name | Acronym/Abbreviation/Initialism |
|---|---|
| Access Category | AC |
| Access Point | AP |
| Distributed Coordination Function | DCF |
| Downlink | DL |
| Enhanced Distributed Channel Access | EDCA |
| Enhanced Distributed Channel Access Function | EDCAF |
| Hybrid Coordination Function | HCF |
| In-Device Coexistence | IDC |
| Internet-of-Things | IoT |
| Multi-Link | ML |
| Multi-Link Device | MLD |
| Multi-Link Logical Entity | MLLE |
| Multi-Link Operation | MLO |
| Non-Simultaneous Transmit and Receive | NSTR |
| Physical | PHY |
| Reception | RX |
| Restricted Target Wake Time | r-TWT |
| Signal-to-Interference-and-Noise-Ratio | SINR |
| Simultaneous Transmit and Receive | STR |
| Station | STA |
| Target Beacon Transmission Time | TBTT |
| Target Wake Time | TWT |
| Transmission | TX |
| Transmission Opportunity | TXOP |
| Ultra-High Reliability | UHR |
| Uplink | UL |
| Wireless LAN | WLAN |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
sending, from a multi-link device (MLD), a minimum transmit power and a maximum transmit power for each of at least a first communication link and a second communication link for use by at least a first communication component and a second communication component of the MLD, respectively; and
before a start of a scheduled service period, receiving a local transmit power constraint for the scheduled service period for a corresponding one of the first and second communication links;
wherein if a frequency gap between the first communication link and the second communication link is equal to or smaller than a threshold and if the scheduled service period overlaps with another scheduled service period for the other one of the first and second communication links, the local transmit power constraints for the first and second communication links correspond to the respective minimum transmit powers.

2. The communication method according to claim 1, wherein if the frequency gap between the first communication link and the second communication link is larger than the threshold, the local transmit power constraints for the first and second communication links correspond to values smaller than or equal to the respective maximum transmit powers and greater than the respective minimum transmit powers.

3. The communication method according to claim 1, wherein if the frequency gap between the first communication link and the second communication link is equal to or smaller than the threshold and the scheduled service period does not overlap with another scheduled service period for the other one of the first and second communication links, the local transmit power constraints for the first and second communication links correspond to values smaller than or equal to the respective maximum transmit powers and greater than the respective minimum transmit powers.

4. The communication method according to claim 1, wherein said sending the minimum transmit power and the maximum transmit power for each of the first communication link and the second communication link comprises:
sending, via an association request frame, the minimum and maximum transmit powers for each of the first and second communication links;
wherein the association request frame comprises a multi-link power capability element, the multi-link power capability element comprising a control field and a transmit power capabilities field specifying the minimum and maximum transmit powers for each of the first and second communication links; and
wherein the control field comprising a number of links subfield for indicating a number of a plurality of communication links specified in the transmit power capabilities field, the plurality of communication links comprising the first and second communication links.

5. The communication method according to claim 1, wherein receiving the local transmit power constraint for the scheduled service period for the corresponding one of the first and second communication links comprises receiving a power-controlled Target Wake Time (TWT) information frame specifying the local transmit power constraint for the scheduled service period for the corresponding one of the first and second communication links.

6. The communication method according to claim 5, further comprising receiving, by the MLD, an association response frame containing a TWT element, wherein a TWT information frame disabled subfield of the TWT element is set to a predetermined value to indicate that reception of the power-controlled TWT information frame is enabled by at least one of a plurality of communication components of the MLD, the plurality of communication components comprising the first and second communication components.

7. The communication method according to claim 5, wherein the power-controlled TWT information frame comprises an action field containing an unprotected sub-1-GHz (S1G) action subfield, and a predetermined value of the unprotected S1G action field represents a power-controlled TWT information frame.

8. The communication method according to claim 5, wherein the power-controlled TWT information frame comprises a power-controlled TWT information field specifying the local transmit power constraint for the corresponding one of the first and second communication links.

9. The communication method according to claim 1, wherein said sending the minimum transmit power and the maximum transmit power for each of the first communication link and the second communication link comprises:
sending, via an association request frame, the minimum and maximum transmit powers for each of the first and second communication links;
wherein the association request frame comprises a first power-controlled TWT element, the power-controlled TWT element comprising a power-controlled TWT parameter information field specifying the minimum and maximum transmit powers for each of one or more of a plurality of communication components of the MLD, the plurality of communication components comprising the first and second communication components.

10. The communication method according to claim 9,
wherein the power-controlled TWT element further comprises a control field containing a power-controlled TWT information frame disabled subfield, wherein a value of the power-controlled TWT information frame disabled subfield indicates both a capability of receiving power-controlled TWT information frames and a presence of the minimum and maximum transmit powers for each of the one or more of the plurality of communication components in the power-controlled TWT parameter information field.

11. A communication apparatus for use in a multi-link device (MLD), the communication apparatus comprising at least one processing unit and at least one transceiver, wherein:
the at least one transceiver is configured to send a minimum transmit power and a maximum transmit power for each of at least a first communication link and a second communication link for use by at least a first communication component and a second communication component of the MLD, respectively; and
before a start of a scheduled service period, receive a local transmit power constraint for the scheduled service period for a corresponding one of the first and second communication links; and
wherein if a frequency gap between the first communication link and the second communication link is equal to or smaller than a threshold and if the scheduled service period overlaps with another scheduled service period for the other one of the first and second communication links, the local transmit power constraints for the first and second communication links correspond to the respective minimum transmit powers.

12. The communication apparatus according to claim 11, wherein if the frequency gap between the first communication link and the second communication link is larger than the threshold, or if the frequency gap between the first communication link and the second communication link is equal to or smaller than the threshold and the scheduled service period does not overlap with another scheduled service period for the other one of the first and second communication links, the local transmit power constraints for the first and second communication links correspond to values smaller than or equal to the respective maximum transmit powers and greater than the respective minimum transmit powers.

13. The communication apparatus according to claim 11, wherein said at least one transceiver being configured to send the minimum transmit power and the maximum transmit power for each of the at least the first and second communication links comprises:
said at least one transceiver being configured to send, via an association request frame, the minimum and maximum transmit powers for each of the first and second communication links;
wherein the association request frame comprises a multi-link power capability element, the multi-link power capability element comprising a control field and a transmit power capabilities field specifying the minimum and maximum transmit powers for each of the first and second communication links; and
wherein the control field comprising a number of links subfield for indicating a number of a plurality of communication links specified in the transmit power capabilities field, the plurality of communication links comprising the first and second communication links.

14. The communication apparatus according to claim 11, wherein said at least one transceiver being configured to receive the local transmit power constraint for the scheduled service period for the corresponding one of the first and second communication links comprises said at least one transceiver being configured to receive a power-controlled TWT information frame specifying the local transmit power constraint for the scheduled service period for the corresponding one of the first and second communication links.

15. The communication apparatus according to claim 14, wherein said at least one transceiver is further configured to:
receive an association response frame containing a Target Wake Time (TWT) element, wherein a TWT information frame disabled subfield of the TWT element is set to a predetermined value to indicate that reception of the power-controlled TWT information frame is enabled by at least one of a plurality of communication components of the MLD, the plurality of communication components comprising the first and second communication components.

16. The communication apparatus according to claim 14, wherein the power-controlled TWT information frame comprises an action field containing an unprotected sub-1-GHz (S1G) action field, and a predetermined value of the unprotected S1G action field represents a power-controlled TWT information frame.

17. The communication apparatus according to claim 14, wherein the power-controlled TWT information frame comprises a power-controlled TWT information field specifying the local transmit power constraint for the corresponding one of the first and second communication links.

18. The communication apparatus according to claim 11, wherein said at least one transceiver being configured to send the minimum transmit power and the maximum transmit power for each of at least the first communication link and the second communication link comprises:
said at least one transceiver being configured to send, via an association request frame, the minimum and maximum transmit powers for each of the first and second communication links;
wherein the association request frame comprises a first power-controlled TWT element, the first power-controlled TWT element comprising a power-controlled TWT parameter information field specifying the minimum and maximum transmit powers for each of one or more of a plurality of communication components of the MLD, the plurality of communication components comprising the first and second communication components.

19. The communication apparatus according to claim 18,
wherein the power-controlled TWT element further comprises a control field containing a power-controlled TWT information frame disabled subfield, wherein the power-controlled TWT information frame disabled subfield indicates both a capability of receiving local transmit power constraints and a presence of the minimum and maximum transmit powers for each of the at least one of the first and second communication links in the power-controlled TWT parameter information field.

20. One or more non-transitory computer-readable storage devices comprising computer-executable instructions, wherein the computer-executable instructions, when executed, cause one or more circuits to perform a communication method comprising:
sending, from a multi-link device (MLD), a minimum transmit power and a maximum transmit power for each of at least a first communication link and a second communication link for use by at least a first communication component and a second communication component of the MLD, respectively; and
before a start of a scheduled service period, receiving a local transmit power constraint for the scheduled service period for a corresponding one of the first and second communication links;
wherein if a frequency gap between the first communication link and the second communication link is equal to or smaller than a threshold and if the scheduled service period overlaps with another scheduled service period for the other one of the first and second communication links, the local transmit power constraints for the first and second communication links correspond to the respective minimum transmit powers.
